(19) United States
(12) Patent Application Publication
(10) Pub. No.: US 2022/0358061 A1
(43) Pub. Date: Nov. 10, 2022

(54) UNMATCHED ARCHITECTURE COMPENSATION VIA DIGITAL COMPONENT DELAY

(71) Applicant: Intel Corporation, Santa Clara, CA (US)

(72) Inventors: Jai Ram SILIVERI, Warangal (IN); Pooja K. JADHAV, Davanagere (IN); Sampath DAKSHINAMURTHY, Bangalore (IN); Mohammad M. RASHID, San Jose, CA (US); Lohit YERVA, Mountain View, CA (US)

(21) Appl. No.: 17/873,035

(22) Filed: Jul. 25, 2022

(51) Int. Cl. G06F 13/16

(52) U.S. Cl. CPC G06F 13/1673

(57) ABSTRACT

In a memory subsystem, a physical interface (PHY) has an unmatched architecture. To compensate for the unmatched architecture, the PHY has variable delay compensation to adjust for propagation mismatch of analog signals in the data (DQ) path and data strobe (DQS) path of the PHY. The variable delay compensation can be provided by adjusting the operation of a digital component of the PHY to introduce the delay compensation.

### FIELD

Descriptions are generally related to integrated circuit communication, and more particular descriptions are related to delay compensation for an unmatched architecture.

### BACKGROUND

Source synchronous parallel input/output (IO) and memory IO send a data strobe as a clock reference signal along with the data signal. For a write request, the source device (the device that generates the request) sends the strobe with the write data. For a read request the source device that generates the request receives data and a data strobe from the target device.

A matched architecture is common, where both the data and the strobe travel through the same impedance delay (e.g., the RC or resistive-capacitive delay). A matched architecture typically includes buffers along the data path to have the data propagation match the strobe. For low signaling interfaces such as high bandwidth memory IO (HBMIO), the interface wastes significant power while traversing from low voltage signals at the 10 to a high voltage interface at the memory device. The wasted power results from the amplification of a low voltage signal to a high voltage signal.

In an unmatched architecture, there is misalignment between the data signal and the strobe signal. The mismatch would cause incorrect data sampling in the device receiving the data. While an unmatched architecture does not have the same power loss as traditional low voltage signaling IOs, the signal propagation delay mismatch will result in data sampling at the wrong time.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1A is a block diagram of an example of a system with a physical interface that provides delay compensation for an unmatched data communication architecture.

FIG. 1B is a block diagram of an example of a memory subsystem with the unmatched data communication architecture of FIG. 1A.

FIG. 2 is a block diagram of an example of a physical interface that provides delay compensation for an unmatched data communication architecture.

FIG. 3 is a block diagram of an example of a system in which the data paths have analog delay compensation for an unmatched data communication architecture.

FIG. 4 is a block diagram of an example of a system in which the data paths have digital delay compensation for an unmatched data communication architecture.

FIGS. 5A-5D are timing diagrams of an example of providing 1 UI delay compensation in a transmit data path.

FIGS. 6A-6D are timing diagrams of an example of providing 2 UI delay compensation in a transmit data path.

FIGS. 7A-7D are timing diagrams of an example of providing 3 UI delay compensation in a transmit data path.

FIGS. 8A-8D are timing diagrams of an example of providing 1 UI delay compensation in a receive data path with selective FIFO swapping.

FIGS. 9A-9D are timing diagrams of an example of providing 2 UI delay compensation in a receive data path with selective FIFO swapping.

FIGS. 10A-10D are timing diagrams of an example of providing delay compensation for mismatch of 1UI and a partial UI in a transmit data path.

FIG. 11 is a flow diagram of an example of a process for write operation with delay compensation in the physical interface.

FIG. 12 is a flow diagram of an example of a process for read operation with delay compensation in the physical interface.

FIG. 13 is a block diagram of an example of a memory subsystem in which delay compensation for an unmatched architecture provided by a physical interface can be implemented.

FIG. 14 is a block diagram of an example of a computing system in which delay compensation for an unmatched architecture provided by a physical interface can be implemented.

FIG. 15 is a block diagram of an example of a mobile device in which delay compensation for an unmatched architecture provided by a physical interface can be implemented.

Descriptions of certain details and implementations follow, including non-limiting descriptions of the figures, which may depict some or all examples, and well as other potential implementations.

### DETAILED DESCRIPTION

As described herein, a system has a physical interface (PHY) with an unmatched architecture. An unmatched architecture can save power relative to a matched architecture by not needing the amplification of a low voltage signal to high voltage signal for communication used in a matched architecture. An unmatched architecture can use low voltage signaling, saving power.

A source synchronous parallel input/output (IO) or memory IO such as high bandwidth memory IO (HBMIO), double data rate 10 (DDRIO), low power double data rate (LPDDRIO), has a strobe that is sent along with the data from transmitter to receiver. An unmatched architecture does not guarantee a common phase or resistive-capacitive (RC) delay during propagation of the data signal and the strobe signal like a matched architecture. Thus, during a capture of the data on the receiver side based on the strobe, the strobe can be unmatched with respect to the data. In many cases it is the data signal that experiences shorter RC delay than the strobe.

To compensate for the misalignment between the data signal and the strobe signal for an unmatched architecture, the PHY has variable delay compensation to adjust for propagation mismatch of analog signals in the data (DQ) path and data strobe (DQS) path of the PHY. The mismatch generally refers to the misalignment between the changing edge in the strobe signal that triggers sampling and the peak of the data signal eye, or the point in the data eye where the signal can be reliably sampled. The mismatch can be referred to as a timing mismatch, referring to the sample timing, a phase mismatch, referring to the phase offset between the strobe and the data, or a delay mismatch, referring to the difference in propagation delay between the strobe and the data.

The mismatch can be one or multiple unit intervals (UIs) or a subpart of a UI, or one or more UIs plus a subpart of a UI. A UI refers to a signaling/sampling interval for the data communication. For double data rate communication, the UI can be a clock/strobe transition (low to high and high to low). For other systems, the UI can be from one transition type to the following transition of the same type (from low-to-high to low-to-high, or from high-to-low to high-to-low).

In one example, the PHY provides the variable delay compensation through analog delay components on the signal lines. In one example, the PHY provides the variable delay compensation by adjusting the operation of a digital component of the PHY to introduce the delay compensation. In one example, the digital component can apply a delay in increments of one or more UIs. In one example, the digital component is a queue structure, such as a first in, first out (FIFO) buffer in the PHY. A queue structure can already be included in the PHY for data transfer between different clock domains. For example, in a host system data path implements a FIFO structure for data transfer from/to a native clock domain on which the PHY layer is working to/from the clock domain on which a memory device is working.

Adjustment or control of the operation of the queue structure can resolve the misalignment between the data signal and strobe signal in terms of UIs for a number, N, of UI shifts that the unmatched architecture introduces. In one example, the control of the operation of the digital component is hardware controlled. In one example, the control of the operation of the digital component is software controlled.

Consider communication between a memory device and a memory controller of the host, such as an integrated memory controller (iMC) on a processor chip or processor system on a chip (SOC). The processor can be a central processing unit (CPU), graphics processing unit (GPU), or other processing device. The delay mismatch can be present at the memory device receiver and the PHY receiver side. In one example, the host PHY is responsible to compensate for the mismatch in both the memory device and the host PHY.

In one example, a digital component in the PHY introduces delay to compensate for the mismatch between the DQ path and DQS path. In one example, the compensation for delay in the memory device is performed through the PHY's transmitter side. In one example, the compensation for delay in the PHY receiver is performed through the PHY's receiver side.

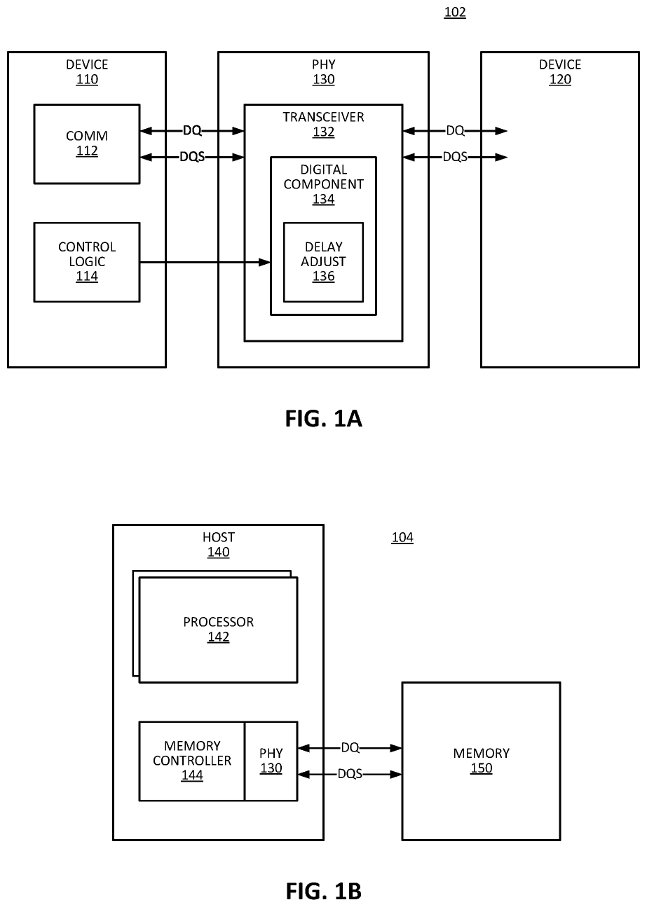

FIG. 1A is a block diagram of an example of a system with a physical interface that provides delay compensation for an unmatched data communication architecture. System 102 represents a system where two devices communicate with a source synchronous clocking architecture. More particularly, system 102 has device 110 to communicate with device 120 with an unmatched source synchronous clocking architecture.

PHY 130 represents the physical interface between device 110 and device 120. In one example, PHY 130 is part of device 110. In one example, PHY 130 is a circuit in a multi-die device of which device 110 is part, such as a multi-die processing unit with a memory controller and a memory interface circuit. In one example, PHY 130 can be part of device 120.

One example of an implementation of system 102 can be a memory subsystem, where device 110 represents a memory controller and device 120 represents a memory device. In such an implementation, device 120 can represent an integrated memory controller (iMC) or a circuit on a tile. PHY 130 can be on the same die or same tile as the memory controller, or can be part of another circuit tile to interface with the memory. The memory device can be a high bandwidth memory (HBM) device, a double data rate (DDR) dynamic random access memory (DRAM) device, a low power DDR (LPDDR) DRAM, or other memory.

In one example, device 110 includes communication (COMM) logic 112 or other logic to send data to device 120. Communication logic 112 can transmit data (DQ) and a strobe (DQS) signal when device 110 is the source of the data exchange. When device 110 is the data receiver and device 120 is the data source, communication logic 112 can receive the DQ and DQS signals. Transceiver 132 represents transmitter/receiver circuitry in PHY 130.

With an unmatched architecture, there can be a mismatch between the DQ signal and the DQS signal. In one example, transceiver 132 includes digital component 134 used in the buffering or receiving or transmitting of data. Control logic 114 of device 110 represents control of the operation of digital component 134. With control logic 114, digital component 134 can introduce an adjustment to compensate for the mismatch between DQ and DQS. Delay adjust 136 represents the adjust to the delay mismatch.

In one example, digital component 134 represents the existing queue structure used for data transfer between different clock domains in PHY 130. Delay adjust 136 can represent an adjustment to the operation of the queue structure (e.g., a FIFO ora shifter) to resolve the misalignment between DQ and DQS in terms of UI for a number N of UI shifts that the unmatched architecture can introduce. In one example, control logic 114 is implemented as hardware within device 110 to control the UI shift of digital component 134. In one example, control logic 114 is implemented as software/firmware within device 110 to control the UI shift of digital component 134.

Delay adjust 136 can adjust the delay of the data signals with the queue structure to balance the delay added at the strobe at the receiver, which can align DQ with DQS for proper sampling. In one example, delay adjust 136 represents control over a write pointer for digital component 134, to control how to write entries into digital component 134 to compensate for the mismatch.

In one example, system 102 can delay the write of data into digital component 134 for transactions where device 110 is the data source, and can control the read into digital component 134 for transactions where device 120 is the data source. The adjustment of the delay mismatch based on the operation of digital component 134 can introduce delay into the data exchange to compensate for the delay mismatch between DQ and DQS, while hiding the latency associated with the added delay in the operation of digital component 134. Thus, system 102 can allow for an unmatched architecture by compensating for delay mismatches while reducing or eliminating the performance impact of the added delay.

In one example, control logic 114 or other logic in device 110 can perform training on the communication link to determine the delay offset between DQ and DQS. The logic can perform the training periodically or at key times to identify what delay adjust 136 needs to do to adjust the operation of digital component 134. Digital component 134 can receive a control signal from control logic 114 cause it to introduce delay compensation based on delay adjust 136. Delay adjust 136 can compensate for the delay propagation mismatch between DQ and DQS.

It will be understood that the data strobe used to sample the data undergoes delay at the end of the receiving device due to the unmatched architecture. In one example, it is the responsibility of the physical layer (PHY 130) to send the data from the sending device to the receiving device to ensure that when receiver samples the data, the receiver will sample the data with respect to the strobe correctly and with good margin. The margin refers to the data eye margin. In one example, PHY 130 does not introduce any data delay, which results in no data bus occupancy issue. In one example, PHY 130 compensates for the delay added on the strobe by the receiving device. In one example, system 102 trains and provides the delay compensation once during boot or waking of the receiving device, and does not provide delay compensation training during functional traffic. If there is bus training during functional traffic, the delay compensation could result in stalling of the data bus.

FIG. 1B is a block diagram of an example of a memory subsystem with the unmatched data communication architecture of FIG. 1A. System 104 represents a system in accordance with an example of system 102. System 104 specifically illustrates communication for a memory subsystem, with memory controller 144 to exchange data (DQ) signals and strobe (DQS) signals with memory 150.

System 104 includes host 140, which represents a hardware platform on which system 104 is implemented. Host 140 can represent a computing device or a processor device, which can include an implementation where the processor device has integrated components. Processor 142 represents the host processor. Processor 142 can be or include a single core or multicore processor. In one example, processor 142 represents a CPU (central processing unit). In one example, processor 142 represents a GPU (graphics processing unit).

Memory controller 144 represents a controller to manage access to memory 150. Memory 150 can be or include one or multiple memory devices. In one example, memory 150 includes LPDDR (low power double data rate) DRAM devices. In one example, memory 150 includes DDR (double data rate) DRAM devices. In one example, memory 150 includes HBM (high bandwidth memory or stacked memory) DRAM devices. In one example, memory 150 is or includes a memory module with multiple discrete memory chips. In one example, memory 150 is a stacked memory device with multiple discrete memory chips. In one example, memory 150 is integrated memory with multiple memory tiles.

In one example, memory controller 144 is part of processor 142, such as an integrated memory controller circuit. In one example, memory controller 144 is a circuit in a tile or chip separate from the core computing circuits of processor 142. PHY 130 represents an example of PHY 130 of system 102. In one example, PHY 130 is part of memory controller 144. In one example, PHY 130 is part of memory 150. Typically, PHY 130 is part of host 140.

In one example, PHY 130 includes multiple FIFO structures that have FIFO pointers used to control the write and read operation of the FIFO. The FIFO pointers can include a write pointer. The FIFO pointers can include a read pointer. In one example, PHY 130 can receive a control signal to adjust the operation of the write pointer, the read pointer, or both the write pointer and the read pointer. With adjustment of the operation of the pointer(s), the traditional fixed latency through FIFO can be a variable latency that compensates for the unmatched architecture.

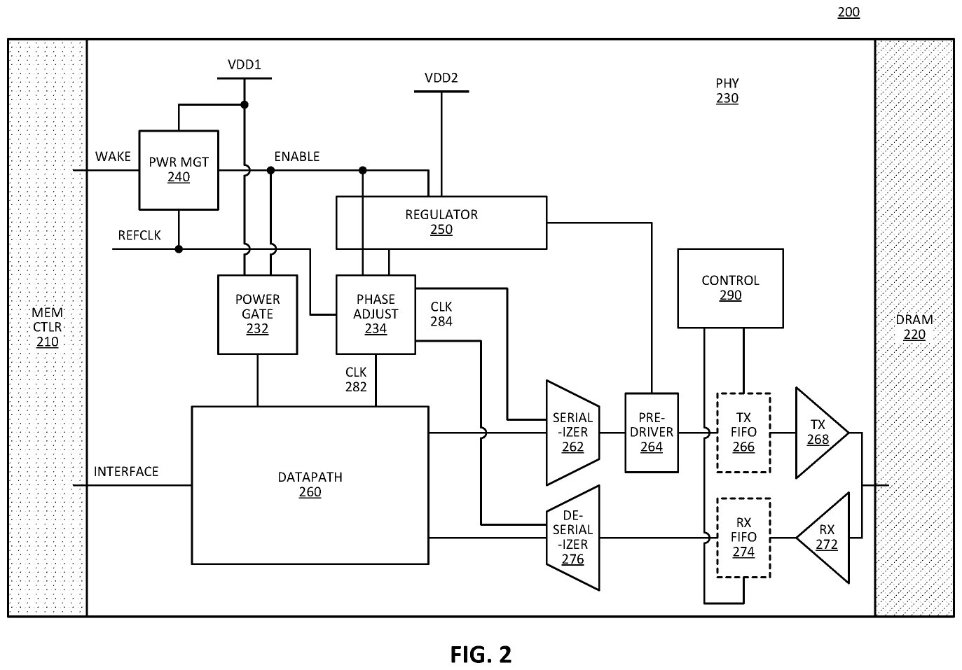

FIG. 2 is a block diagram of an example of a physical interface that provides delay compensation for an unmatched data communication architecture. System 200 represents a system in accordance with an example of system 102 or an example of system 104. PHY 230 represents a physical interface or physical interface circuit that couples DRAM (dynamic random access memory) 220 to memory controller (MEM CTRL) 210.

PHY 230 illustrates datapath 260, which represents a path for the data to be exchanged. In one example, datapath 260 is a DDR PHY interface (DFI) path. When memory controller 210 generates a command for DRAM 220 during normal operation, it will pass through datapath 260. Datapath 260 represents a hardware datapath that prepares the command and address signals for transmission to DRAM 220. Power gate 232 represents a power gate to control the power state of the high speed clock path. Power gate 232 can disable datapath 260 for a low power state, such as when DRAM 220 is in self-refresh.

Phase adjust 234 represents circuitry to generate the clock for the command signals through datapath 260. Phase adjust 234 can receive a reference clock represented as REFCLK. In one example, REFCLK can be a lower speed clock input that PHY 230 uses to generate a high speed clock signal for datapath 260. In one example, phase adjust 234 generates CLK 282, which can represent one or more clock signals to control datapath 260. In one example, phase adjust 234 includes multiple levels or a sequence of adjustments to the clock. In one example, phase adjust 234 includes a phase locked loop (PLL). In one example, phase adjust 234 includes a delay locked loop (DLL). In one example, phase adjust 234 includes a frequency locked loop (FLL).

CLK 284 represents a final clock signal output by phase adjust 234. Phase adjust 234 can provide CLK 284 as a control signal for serializer 262, which can receive the signals from datapath 260. In some implementations, serializer 262 can take parallel bits and generate a serial stream that is controlled for phase and delay. Predriver 264 represents circuitry to prepare the signals and clock or strobe for transmission. TX 268 represents a transmitter to transmit the signals to DRAM 220. The signals can include data (DQ) signals and a data strobe (DQS) signal(s).

For received data, RX 272 can receive the data from DRAM 220, provide the signals to deserializer 276. Phase adjust 234 can provide CLK 284 as a control signal for deserializer 276, which can receive the signals for input data and provide them to datapath 260. In some implementations, deserializer 276 can take a stream of serial bits and generate parallel bits that are controlled for phase and delay.

In one example, PHY 230 includes regulator 250, which can represent one or more low voltage regulators (LVRs). Regulator 250 can be implemented as a feedback loop; thus, with narrower bandwidth it will be more stable, with less oscillation. Regulator 250 can provide control signals or reference signals for phase adjust 234. Regulator 250 or other voltage regulation can be used to create a low noise power supply, enabling higher I/O frequencies than would be possible with a noisy supply. System 200 illustrates regulator 250 receiving a high voltage reference signal (VDD2) as an input. Regulator 250 can operate based on VDD2, which can be an ungated power supply. In one example, regulator 250 provides a control signal or reference signal to predriver 264.

PHY 230 includes power management (PWR MGT) 240. Power management 240 represents circuitry to control the power use of the circuitry in PHY 230. In one example, power management 240 receives a high voltage reference signal (VDD1) as an input. Power management 240 can operate based on VDD1, which can be an ungated power supply. In one example, power management 240 generates an enable signal based on a wake signal (WAKE) received from memory controller 210.

In one example, PHY 230 includes transmit (TX) first in, first out (FIFO) 266, which represents a transmit buffer or a write buffer. In one example, PHY 230 includes receive (RX) FIFO 274, which represents a receive buffer or a read buffer. Control 290 represents control either in PHY 230 or in memory controller 210 to provide control signals to TX FIFO 266 or to RX FIFO 274. The control signals can adjust the operation of either or both of the FIFOs. The FIFOs can be separately controlled. The phase adjustment on transmit and receive can be different.

In one example, system 200 controls the delay adjustment for delay mismatch based on controlling the operation of TX FIFO 266 for transmit or write transactions and controlling the operation of RX FIFO 274 for receive or read transactions. In one example, the control signals control the writing to the FIFO, the reading from the FIFO, or both the writing to the FIFO and the reading from the FIFO. In one example, TX FIFO 266 and RX FIFO 274 are the same FIFO. In one example, the FIFO is implemented as multiple (e.g., two) separate FIFO circuits that function together. Splitting the FIFO into two or more circuits can provide greater control over the granularity of phase control. For example, using a single FIFO could limit the phase adjustment to 2 UI shifts, whereas using two FIFO structures as a single FIFO device in the data path can allow phase adjustments of 1 UI.

Consider a FIFO with a depth of N (e.g., 6, 8, 12, or some other number). Instead of writing into the FIFO at the first slot, the system can write later, farther down the depth of the queue. Writing later into the FIFO can introduce a skew to compensate for mismatch in strobe or sampling clock signal to align the data with the strobe.

While system 200 represents one or more digital components in the data path, PHY 230 could alternatively include one or more digital components in a data strobe path. The data strobe path can be the path of CLK 284. Instead of control over the data buffers of the data path, PHY 230 can include a shifter in the data strobe path. For example, phase adjust 234 can include a shifter to adjust the timing of the sampling of data in datapath 260. In one example, system 200 can cause the shifter to launch later.

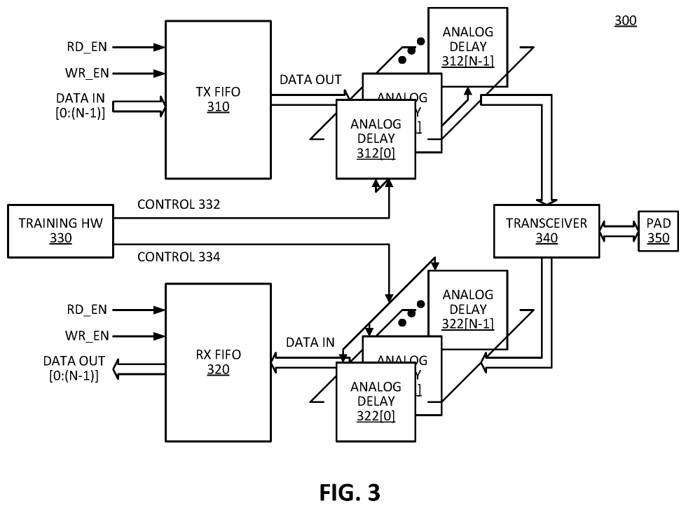

FIG. 3 is a block diagram of an example of a system in which the data paths have analog delay compensation for an unmatched data communication architecture. System 300 represents an alternative to system 102 or system 104. Whereas system 102 and system 104 include digital components to introduce delay compensation, system 300 provides delay compensation with analog components in each signal line of the data path.

In system 300, TX FIFO 310 represents a write buffer, which can receive read enable (RD_EN), write enable (WR_EN), and data in signals. Data in is illustrated as having N bits. TX FIFO 310 generates data out. System 300 can include N analog delay lines, represented as analog delay 312[0:(N-1)], collectively analog delay 312. Analog delay 312 represents variable length analog delay in the write path to compensate for the unmatched architecture, to delay the data relative to the data strobe. As illustrated in system 300, each bit has a corresponding analog delay 312.

In system 300, RX FIFO 320 represents a read buffer, which can receive read enable (RD_EN) and write enable (WR_EN) control signals, and provides N bits of data out. System 300 can include N analog delay lines, represented as analog delay 322[0:(N-1)], collectively analog delay 322. Analog delay 322 represents variable length analog delay in the read path to compensate for the unmatched architecture, to delay the data relative to the data strobe. As illustrated in system 300, each bit has a corresponding analog delay 322.

TX FIFO 310 can provide write or transmit data through analog delay 312 to transceiver 340, which is delay compensated relative to the data strobe. Thus, data transmitted from pad 350 will have the proper alignment with the data strobe for sampling. RX FIFO 320 can receive read data from pad 350, through transceiver 340, and through analog delay 322. The received data is properly delayed relative to the strobe signal for capture by RX FIFO 320.

System 300 illustrates training hardware (HW) 330, which generates the variable delay code controls to walk through different delays that the data will undergo. Training hardware 330 can then latch onto the best delay code at which the data is sampled properly by the strobes. Control 332 represents control signals to analog delay 312. Control 334 represents control signals to analog delay 322.

System 300 adds variable delay lines to each signal line path to modulate the delay shift. System 300 can provide proper signal delay for memory IOs (e.g., HBMIO, LPDDRIO, DDRIO) or other source synchronous communication. Typically, the delay lines will have different tap points providing different delays across each of the tap points. The tap points are control registers or fuses that can be programmed for each part. The delay lines are analog components that interface with the digital system via control bits or fuses.

Relative to the application of variable delay with a digital component as in system 102, system 104, or system 400 (below), system 300 has increased power dissipation, increased area, is not process agnostic, and does not have deterministic delay.

With the use of a digital component, the analog components of system 300 do not need to be included to provide the variable delay. Without delay lines on each bit, there are fewer analog components, which saves area in the PHY layer circuitry, as well as saving power dissipation.

The use of analog delay lines in accordance with system 300 is not process agnostic. It will be understood that analog components typically need to be built differently and hardened for each process node. Thus, the design is not necessarily scalable to all implementation designs.

Furthermore, although analog delay lines have coarse and fine-tuned delay lines, the exact delay that is achieved across a particular control register or tap point is not deterministic. The non-determinism increases as different processes or different types of semiconductor materials are used for the components.

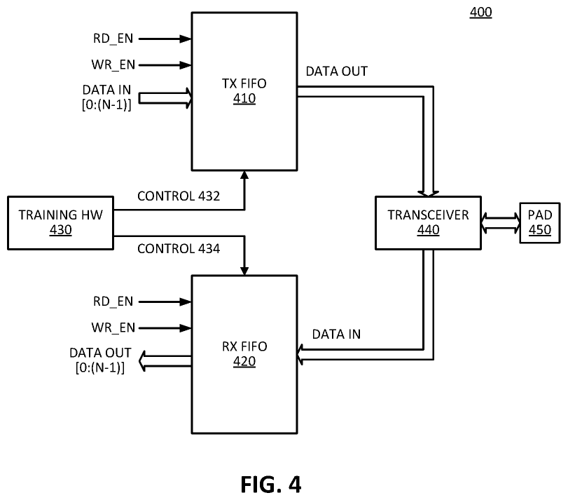

FIG. 4 is a block diagram of an example of a system in which the data paths have digital delay compensation for an unmatched data communication architecture. System 400 represents a system in accordance with an example of system 102 or an example of system 104. System 400 provides an alternative to system 300. System 400 introduces delay compensation with digital component(s) in the data path.

System 400 includes TX FIFO 410 and RX FIFO 420. In system 400, TX FIFO 410 represents a write buffer, which can receive read enable (RD_EN), write enable (WR_EN), and data in signals. Data in is illustrated as having N bits. TX FIFO 410 generates data out. TX FIFO 410 can provide the N bits of data to transceiver 440 without the need for analog delay components because system 400 adjusts the operation of TX FIFO 410 to provide delay compensation for the unmatched architecture. Transceiver 440 sends the transmit data through pad 450 to the receiving device.

In system 400, RX FIFO 420 represents a read buffer, which can receive read enable (RD_EN) and write enable (WR_EN) control signals, and provides N bits of data out. RX FIFO 420 can receive read data through pad 450 from a transmitting device, through transceiver 440. The received data is properly delayed relative to the strobe signal by adjusting the operation of RX FIFO 420, without the need for analog delay components.

In one example, TX FIFO 410 and RX FIFO 420 are existing structures in the data path of system 400. Training hardware (HW) 430 can adjust the operation of the FIFOs through control signals. In one example, control 432 represents control signals to delay the write data by adjusting FIFO pointers for TX FIFO 410. In one example, control 434 represents control signals to delay the read data by adjusting FIFO pointers for RX FIFO 420.

System 400 adds variable delay through the operation of the FIFOs or other digital components in the data paths. System 400 can provide proper signal delay for memory IOs (e.g., HBMIO, LPDDRIO, DDRIO) or other source synchronous communication. Relative to the analog delay lines of system 300, system 400 has reduced power dissipation, decreased area, is process agnostic, and has deterministic delay.

With the use of a digital component, the analog components of system 300 do not need to be included to provide the variable delay. Without delay lines on each bit, there are fewer analog components, which saves area in the PHY layer circuitry, as well as saving power dissipation.

The use of digital components in the data path in accordance with system 400 is process agnostic. It will be understood that digital design is typically scalable across different nodes and different processes.

Furthermore, system 400 can provide edge-aligned delays across the data transfer of queue structures. Thus, the delay is fixed in terms of UI shift. All memory IOs work on clock cycles in terms of minimum UIs, which means system 400 can provide deterministic operation with respect to UIs or clock cycles.

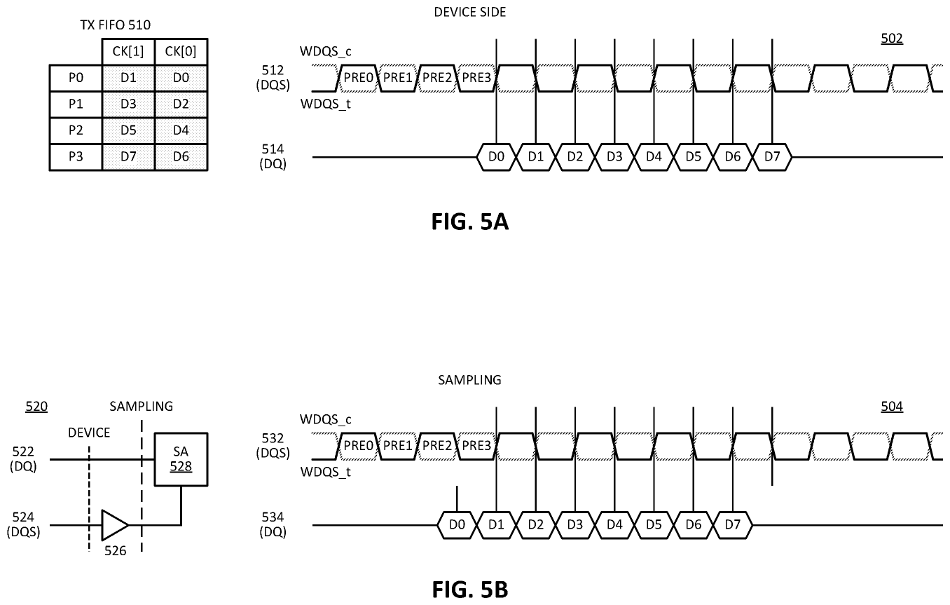

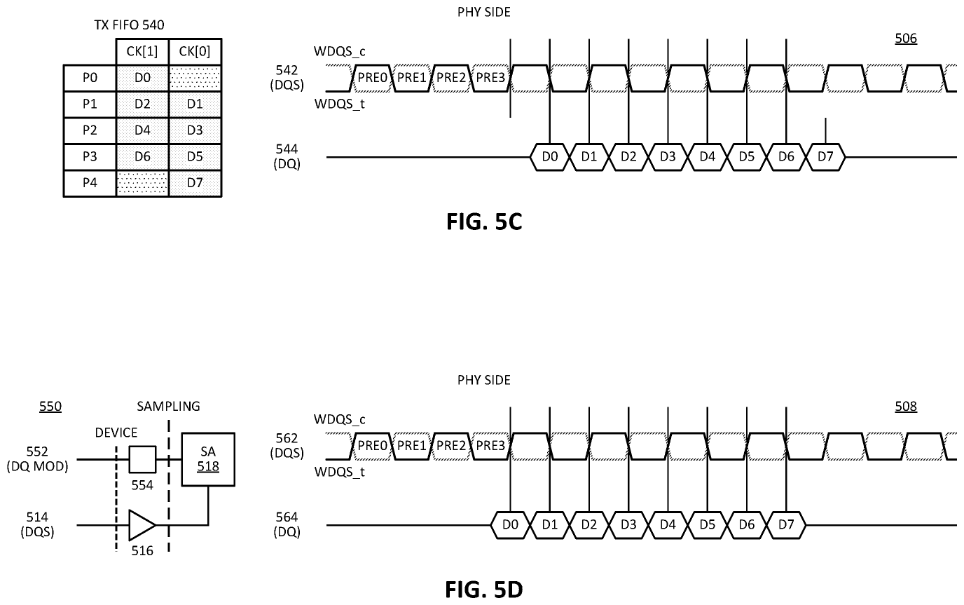

FIGS. 5A-5D are timing diagrams of an example of providing 1 UI delay compensation in a transmit data path. For an implementation of a memory subsystem, the memory device will have a maximum delay between the data and the data strobe at the device receiver. In general, a memory device specification will provide information about the maximum delay. In one example, the PHY Design is capable of compensating the max delay provided in the specification. In one example, the PHY goes through a training mechanism to identify exact delay and lock its configuration settings to compensate for the identified delay.

Consider the delay in terms of UIs, where the UI is defined from the data rate of the device. If the data rate is 6.4 GHz, the unit interval is 156 ps. Let a parameter DQS2DQ_max_del be the maximum delay parameter. With DQS2DQ_max_del of the memory device being 900ps, the maximum in terms of UI is 900/156=approximately 6. Thus, for the PHY design to be capable of compensating the maximum delay provided in the specification, the PHY should be capable of compensating 6UI of delay between DQS2DQ.

FIG. 5A illustrates TX FIFO 510, which represents the FIFO or FIFO buffer on the PHY layer for the ideal case (i.e., without delay on DQS) representing alignment from the device side. Diagram 502 represents a timing diagram for TX FIFO 510. Signal 512 represents a DQS or strobe or sampling signal, with a write strobe (WDQS_t) and the complement (WDQS_c). Signal 512 has a preamble of four clock cycles, represented by PRE[0:3]. Signal 514 represents a DQ or data signal. Signal 514 represents eight bits of data transfer, D[0:7]. It can be observed that at the device side, the DQS and the DQ signals are aligned.

TX FIFO 510 is split into two portions represented as CK[0] and CK[1]. CK[0]represents the FIFO data that will be aligned to the rising edge of WDQS_t and CK[1] represents the FIFO data that will be aligned to the rising edge of WDQS_c. In one example, CK[0] and CK[1] can be written independently, controlled by separate write pointers, and read together with a common read pointer. With a common read pointer, the entire pointer (CK[0] and CK[1]) is read at the same time. For example, P0 has (D1, D0), P1 has (D3, D2), P2 has (D5, D4), and P3 has (D7, D6). Diagram 502 shows that DQ is aligned with respect to WDQS when read from TX FIFO 510.

FIG. 5B illustrates circuit 520, which is not delay compensated. Signal 522 represents a DQ signal and signal 524 represents a DQS signal. Signal 522 and signal 524 cross the device boundary. Circuit 520 has inherent delay in signal 524, as represented by delay 526. In circuit 520, signal 522 and signal 524 cross the sampling boundary for sampling with strong-arm latch (SA) 528 or other sampling circuit. In one example, SA 528 has a comparator and a latch, and is mapped to a slicer.

Diagram 504 represents a timing diagram for circuit 520. Signal 532 represents a DQS or strobe or sampling signal. Signal 532 is illustrated with a write strobe (WDQS_t) and the complement (WDQS_c). WDQS_t is illustrated as the darker line. Signal 532 has a preamble of four clock cycles, represented by PRE[0:3].

Signal 534 represents a DQ or data signal. Signal 534 represents eight bits of data transfer, D[0:7]. It can be observed that due to delay 526, the data signals of signal 534 are ahead of the strobe, which should start sampling after the preamble. Thus, diagram 504 illustrates a 1 clock or 1 UI mismatch. Sampling with the misaligned DQS would cause incorrect data sampling.

FIG. 5C illustrates TX FIFO 540, which represents a digital component in the data path, and more specifically, in the PHY layer. The system can control the operation of TX FIFO 540 to adjust for the unmatched architecture delay represented in diagram 504.

Diagram 506 represents a timing diagram for TX FIFO 540. Signal 542 represents a DQS or strobe or sampling signal, with a write strobe (WDQS_t) and the complement (WDQS_c). Signal 542 has a preamble of four clock cycles, represented by PRE[0:3]. Signal 544 represents a DQ or data signal. Signal 544 represents eight bits of data transfer, D[0:7]. It can be observed that due to the operation of TX FIFO 540, the data signals of signal 544 are delayed by 1 UI.

In one example, a FIFO write point and FIFO data input for TX FIFO 540 are adjusted. By adjusting the write pointers and data input of TX FIFO 540, instead of writing D0 at CK[0], D0 is written in CK[1]. Thus, Pointer 0 or P0 has no data signal at CK[0], and D0 at CK[1]. P1 has D1 at CK[0] and D2 at CK[1]. P2 has D3 at CK[0] and D4 at CK[1]. P3 has D5 at CK[0] and D6 at CK[1]. P4 has D7 at CK[0] and no data at CK[1]. Diagram 506 shows how DQ is delayed by 1 UI with respect to WDQS when read from TX FIFO 540.

FIG. 5D illustrates circuit 550, which provides variable delay through digital components in the data path. Signal 552 represents a modified DQ signal (DQ MOD) and signal 514 represents the DQS signal. Signal 552 and signal 514 cross the device boundary. Circuit 550 illustrates the inherent delay in signal 514 as delay 516. Circuit 550 includes variable delay 554 provided by a TX FIFO 540 in the data path. In circuit 550, delay-adjusted signal 552 and signal 514 cross the sampling boundary for sampling with SA 518.

Diagram 508 represents a timing diagram for circuit 550. Signal 562 represents a DQS or strobe or sampling signal. Signal 562 is illustrated with a write strobe (WDQS_t) and the complement (WDQS_c). WDQS_t is illustrated as the darker line. Signal 562 has a preamble of four clock cycles, represented by PRE[0:3].

Signal 564 represents a DQ or data signal. Signal 564 represents eight bits of data transfer, D[0:7]. It can be observed that variable delay 554 compensates for delay 526, aligning the data signals of signal 564 with the strobe of signal 562. Thus, diagram 508 illustrates a 1 UI compensation.

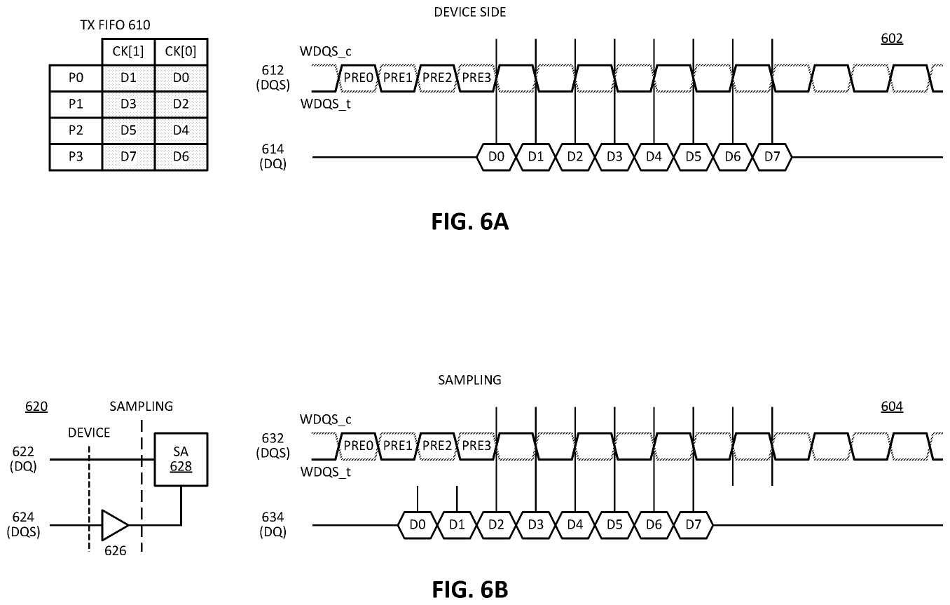

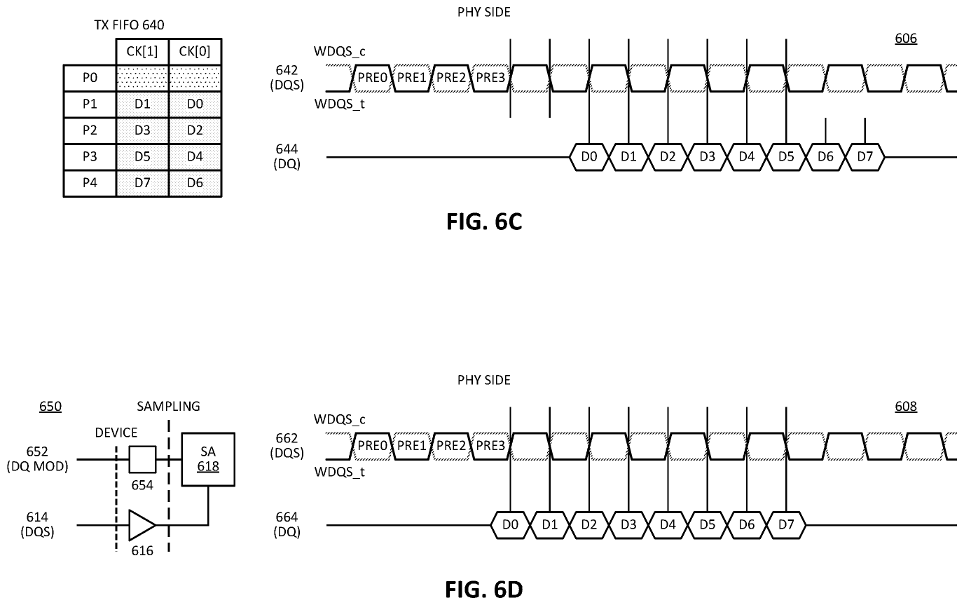

FIGS. 6A-6D are timing diagrams of an example of providing 2 UI delay compensation in a transmit data path. For the 2 UI delay case, the system can adjust the FIFO contents to obtain a 2 UI delay on the data. At the device side, the delay of the DQS by 2 UI will result in proper alignment of the data to the DQS before sampling.

FIG. 6A illustrates TX FIFO 610, which represents the FIFO on the PHY layer of the data path for the ideal case (i.e., without delay on DQS) representing alignment from the device side. Diagram 602 represents a timing diagram for TX FIFO 610. Signal 612 represents a DQS or strobe or sampling signal, with a write strobe (WDQS_t) and the complement (WDQS_c). Signal 612 has a preamble of four clock cycles, represented by PRE[0:3]. Signal 614 represents a DQ or data signal. Signal 614 represents eight bits of data transfer, D[0:7]. It can be observed at the device side, the DQS and the DQ signals are aligned.

TX FIFO 610 is split into two portions represented as CK[0] and CK[1]. CK[0] represents the FIFO data that will be aligned to the rising edge of WDQS_t and CK[1] represents the FIFO data that will be aligned to the rising edge of WDQS_c. In one example, CK[0] and CK[1] can be written independently, controlled by separate write pointers, and read together with a common read pointer. With a common read pointer, the entire pointer (CK[0] and CK[1]) is read at the same time. For example, P0 has (D1, D0), P1 has (D3, D2), P2 has (D5, D4), and P3 has (D7, D6). Diagram 602 shows that DQ is aligned with respect to WDQS when read from TX FIFO 610.

FIG. 6B illustrates circuit 620, which is not delay compensated. Signal 622 represents a DQ signal and signal 624 represents a DQS signal. Signal 622 and signal 624 cross the device boundary. Circuit 620 has inherent delay in signal 624, as represented by delay 626. In circuit 620, signal 622 and signal 624 cross the sampling boundary for sampling with strong-arm latch (SA) 628 or other sampling circuit. In one example, SA 628 has a comparator and a latch.

Diagram 604 represents a timing diagram for circuit 620. Signal 632 represents a DQS or strobe or sampling signal. Signal 632 is illustrated with a write strobe (WDQS_t) and the complement (WDQS_c). WDQS_t is illustrated as the darker line. Signal 632 has a preamble of four clock cycles, represented by PRE[0:3].

Signal 634 represents a DQ or data signal. Signal 634 represents eight bits of data transfer, D[0:7]. It can be observed that due to delay 626, the data signals of signal 634 are ahead of the strobe, which should start sampling after the preamble. Thus, diagram 604 illustrates a 2 UI mismatch. Sampling with the misaligned DQS would cause incorrect data sampling.

FIG. 6C illustrates TX FIFO 640, which represents a digital component in the data path, and more specifically, in the PHY layer. The system can control the operation of TX FIFO 640 to adjust for the unmatched architecture delay represented in diagram 604.

Diagram 606 represents a timing diagram for TX FIFO 640. Signal 642 represents a DQS or strobe or sampling signal, with a write strobe (WDQS_t) and the complement (WDQS_c). Signal 642 has a preamble of four clock cycles, represented by PRE[0:3]. Signal 644 represents a DQ or data signal. Signal 644 represents eight bits of data transfer, D[0:7]. It can be observed that due to the operation of TX FIFO 640, the data signals of signal 644 are delayed by 2 UI.

In one example, a FIFO write point and FIFO data input for TX FIFO 640 are adjusted. Instead of writing D0 in CK[0] of P0, D0 is written in CK[0] of P1. Thus, Pointer 0 or P0 has no data signal at CK[0] of CK[1]. P1 has D0 at CK[0] and D1 at CK[1]. P2 has D2 at CK[0] and D3 at CK[1]. P3 has D4 at CK[0] and D5 at CK[1]. P4 has D6 at CK[0] and D7 at CK[1]. Diagram 606 shows how DQ is delayed by 2 UI with respect to WDQS when read from TX FIFO 640.

FIG. 6D illustrates circuit 650, which provides variable delay through digital components in the data path. Signal 652 represents a modified DQ signal (DQ MOD) and signal 614 represents the DQS signal. Signal 652 and signal 614 cross the device boundary. Circuit 650 illustrates the inherent delay in signal 614 as delay 616. Circuit 650 includes variable delay 654 provided by a TX FIFO 640 in the data path. In circuit 650, delay-adjusted signal 652 and signal 614 cross the sampling boundary for sampling with SA 618.

Diagram 608 represents a timing diagram for circuit 650. Signal 662 represents a DQS or strobe or sampling signal. Signal 662 is illustrated with a write strobe (WDQS_t) and the complement (WDQS_c). WDQS_t is illustrated as the darker line. Signal 662 has a preamble of four clock cycles, represented by PRE[0:3].

Signal 664 represents a DQ or data signal. Signal 664 represents eight bits of data transfer, D[0:7]. It can be observed that variable delay 654 compensates for delay 626, aligning the data signals of signal 664 with the strobe of signal 662. Thus, diagram 608 illustrates a 2 UI compensation.

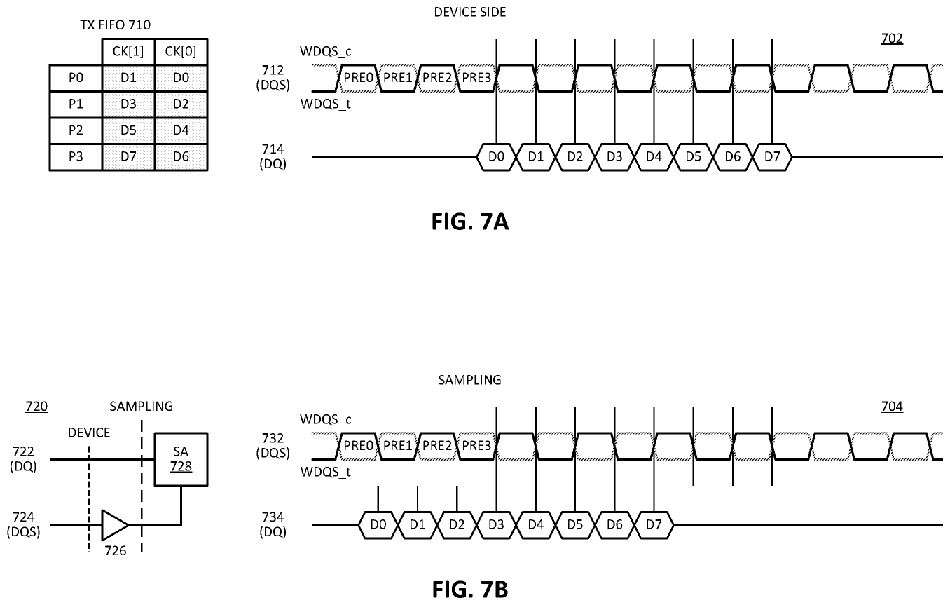

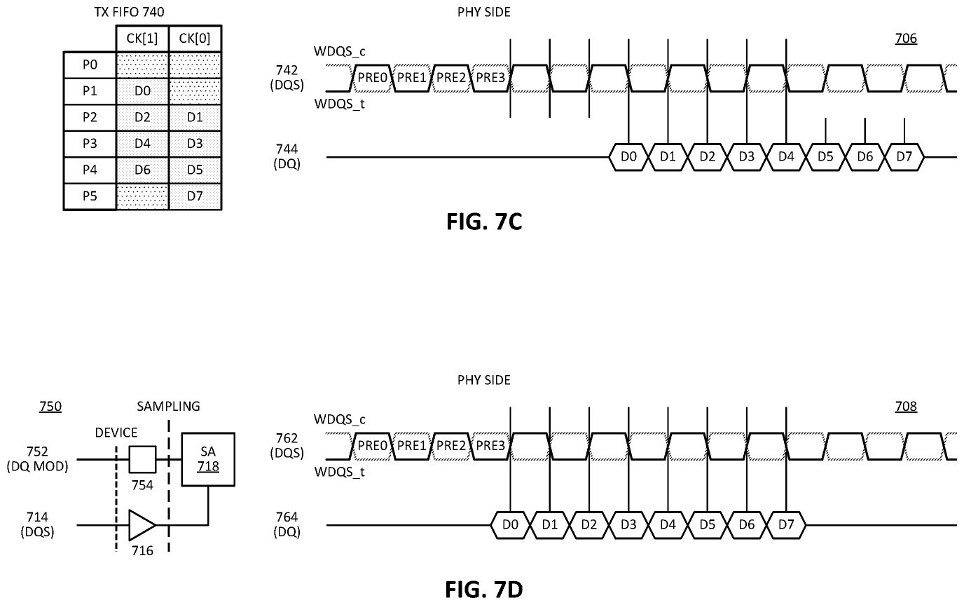

FIGS. 7A-7D are timing diagrams of an example of providing 3 UI delay compensation in a transmit data path. For the 3 UI delay case, the system can adjust the FIFO contents to obtain a 3 UI delay on the data. At the device side, the delay of the DQS by 3 UI will result in proper alignment of the data to the DQS before sampling.

FIG. 7A illustrates TX FIFO 710, which represents the FIFO on the PHY layer of the data path for the ideal case (i.e., without delay on DQS) representing alignment from the device side. Diagram 702 represents a timing diagram for TX FIFO 710. Signal 712 represents a DQS or strobe or sampling signal, with a write strobe (WDQS_t) and the complement (WDQS_c). Signal 712 has a preamble of four clock cycles, represented by PRE[0:3]. Signal 714 represents a DQ or data signal. Signal 714 represents eight bits of data transfer, D[0:7]. It can be observed at the device side, the DQS and the DQ signals are aligned.

TX FIFO 710 is split into two portions represented as CK[0] and CK[1]. CK[0] represents the FIFO data that will be aligned to the rising edge of WDQS_t and CK[1] represents the FIFO data that will be aligned to the rising edge of WDQS_c. In one example, CK[0] and CK[1] can be written independently, controlled by separate write pointers, and read together with a common read pointer. With a common read pointer, the entire pointer (CK[0] and CK[1]) is read at the same time. For example, P0 has (D1, D0), P1 has (D3, D2), P2 has (D5, D4), and P3 has (D7, D6). Diagram 702 shows that DQ is aligned with respect to WDQS when read from TX FIFO 710.

FIG. 7B illustrates circuit 720, which is not delay compensated. Signal 722 represents a DQ signal and signal 724 represents a DQS signal. Signal 722 and signal 724 cross the device boundary. Circuit 720 has inherent delay in signal 724, as represented by delay 726. In circuit 720, signal 722 and signal 724 cross the sampling boundary for sampling with strong-arm latch (SA) 728 or other sampling circuit. In one example, SA 728 has a comparator and a latch.

Diagram 704 represents a timing diagram for circuit 720. Signal 732 represents a DQS or strobe or sampling signal. Signal 732 is illustrated with a write strobe (WDQS_t) and the complement (WDQS_c). WDQS_t is illustrated as the darker line. Signal 732 has a preamble of four clock cycles, represented by PRE[0:3].

Signal 734 represents a DQ or data signal. Signal 734 represents eight bits of data transfer, D[0:7]. It can be observed that due to delay 726, the data signals of signal 734 are ahead of the strobe, which should start sampling after the preamble. Thus, diagram 704 illustrates a 3 UI mismatch. Sampling with the misaligned DQS would cause incorrect data sampling.

FIG. 7C illustrates TX FIFO 740, which represents a digital component in the data path, and more specifically, in the PHY layer. The system can control the operation of TX FIFO 740 to adjust for the unmatched architecture delay represented in diagram 704.

Diagram 706 represents a timing diagram for TX FIFO 740. Signal 742 represents a DQS or strobe or sampling signal, with a write strobe (WDQS_t) and the complement (WDQS_c). Signal 742 has a preamble of four clock cycles, represented by PRE[0:3]. Signal 744 represents a DQ or data signal. Signal 744 represents eight bits of data transfer, D[0:7]. It can be observed that due to the operation of TX FIFO 740, the data signals of signal 744 are delayed by 3 UI.

In one example, a FIFO write point and FIFO data input for TX FIFO 740 are adjusted. Instead of writing D0 in CK[0] of P0, D0 is written in CK[1] of P1. Thus, Pointer 0 or P0 has no data signal at CK[0] or CK[1]. P1 has no data at CK[0] and D0 at CK[1]. P2 has D1 at CK[0] and D2 at CK[1]. P3 has D3 at CK[0] and D4 at CK[1]. P4 has D5 at CK[0] and D6 at CK[1]. P5 has D7 at CK[0]. Diagram 706 shows how DQ is delayed by 3 UI with respect to WDQS when read from TX FIFO 740.

FIG. 7D illustrates circuit 750, which provides variable delay through digital components in the data path. Signal 752 represents a modified DQ signal (DQ MOD) and signal 714 represents the DQS signal. Signal 752 and signal 714 cross the device boundary. Circuit 750 illustrates the inherent delay in signal 714 as delay 716. Circuit 750 includes variable delay 754 provided by a TX FIFO 740 in the data path. In circuit 750, delay-adjusted signal 752 and signal 714 cross the sampling boundary for sampling with SA 718.

Diagram 708 represents a timing diagram for circuit 750. Signal 762 represents a DQS or strobe or sampling signal. Signal 762 is illustrated with a write strobe (WDQS_t) and the complement (WDQS_c). WDQS_t is illustrated as the darker line. Signal 762 has a preamble of four clock cycles, represented by PRE[0:3].

Signal 764 represents a DQ or data signal. Signal 764 represents eight bits of data transfer, D[0:7]. It can be observed that variable delay 754 compensates for delay 726, aligning the data signals of signal 764 with the strobe of signal 762. Thus, diagram 708 illustrates a 3 UI compensation.

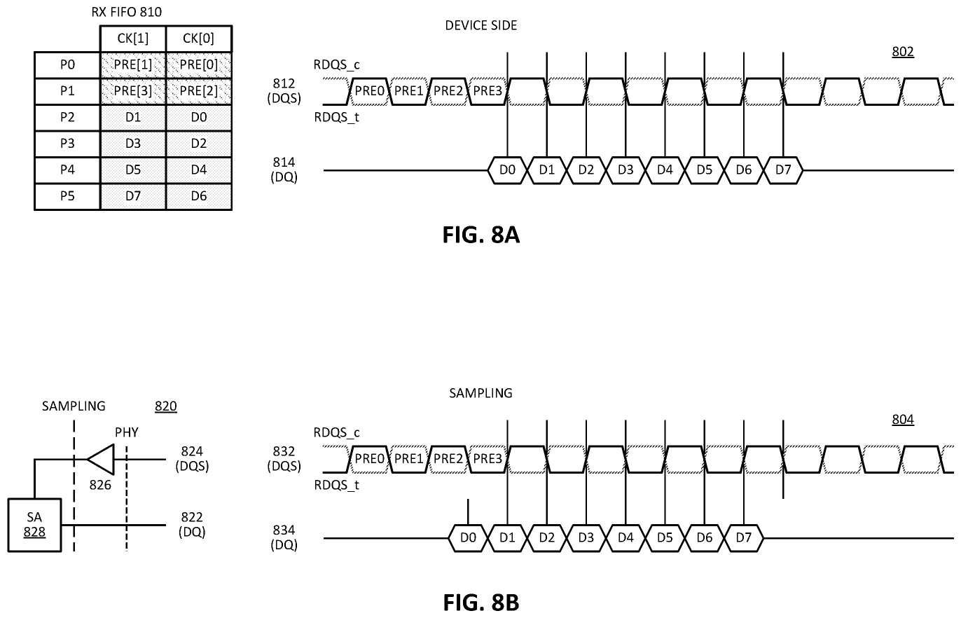

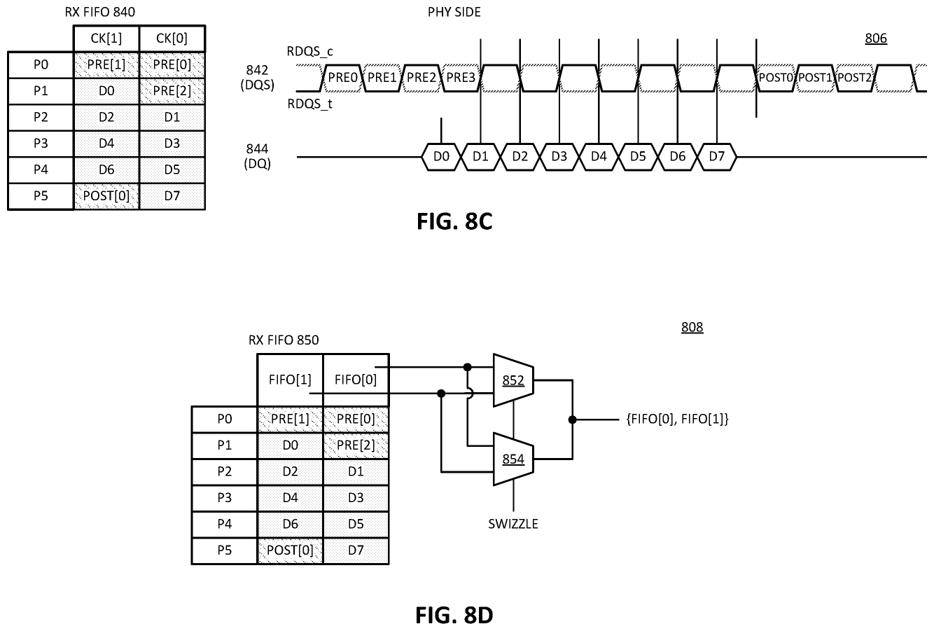

FIGS. 8A-8D are timing diagrams of an example of providing 1 UI delay compensation in a receive data path with selective FIFO swapping. As with the device receiver side, the PHY receiver can also have the delay mismatch between the data and the strobes received. The PHY unmatched receiver compensation will have the strobes delayed.

FIG. 8A illustrates RX FIFO 810, which represents the FIFO on the PHY layer of the data path for the ideal case (i.e., without delay on DQS) representing alignment from the device side. Diagram 802 represents a timing diagram for RX FIFO 810. Signal 812 represents a DQS or strobe or sampling signal, with a read strobe (RDQS_t) and the complement (RDQS_c). Signal 812 has a preamble of four clock cycles, represented by PRE[0:3]. Signal 814 represents a DQ or data signal. Signal 814 represents eight bits of data transfer, D[0:7]. It can be observed at the device side, the DQS and the DQ signals are aligned.

RX FIFO 810 is split into two portions represented as CK[0] and CK[1]. CK[0] represents the FIFO data that is sampled on the rising edge of RDQS_t and CK[1] represents the FIFO data that is sampled on the rising edge of RDQS_c. In one example, CK[0] and CK[1] will have different read pointer controls. In the ideal case, the entire pointer (CK[0] and CK[1]) is read at the same time. For example, P2 has (D1, D0), P3 has (D3, D2), P4 has (D5, D4), and P5 has (D7, D6). P0 has (PRE[1], PRE[0]) and P1 has (PRE[3], PRE[2]). Diagram 802 shows that DQ is aligned with respect to RDQS on the device side when starting at P0 to result in the data {(D1,D0), (D3,D2), (D5,D4), (D7,D6)}.

FIG. 8B illustrates circuit 820, which is not delay compensated. Signal 822 represents a DQ signal and signal 824 represents a DQS signal. Signal 822 and signal 824 cross the PHY boundary. Circuit 820 has inherent delay in signal 824, as represented by delay 826. In circuit 820, signal 822 and signal 824 cross the sampling boundary for sampling with strong-arm latch (SA) 828 or other sampling circuit. In one example, SA 828 has a comparator and a latch.

Diagram 804 represents a timing diagram for circuit 820. Signal 832 represents a DQS or strobe or sampling signal. Signal 832 is illustrated with a read strobe (RDQS_t) and the complement (RDQS_c). RDQS_t is illustrated as the darker line. Signal 832 has a preamble of four clock cycles, represented by PRE[0:3].

Signal 834 represents a DQ or data signal. Signal 834 represents eight bits of data transfer, D[0:7]. It can be observed that due to delay 826, the data signals of signal 834 are ahead of the strobe, which should start sampling after the preamble. Thus, diagram 804 illustrates a 1 UI mismatch. Sampling with the misaligned DQS would cause incorrect data sampling.

FIG. 8C illustrates RX FIFO 840, which represents a digital component in the data path, and more specifically, in the PHY layer. The system can control the operation of RX FIFO 840 to adjust for the unmatched architecture delay represented in diagram 804.

Diagram 806 represents a timing diagram for RX FIFO 840. In one example, RX FIFO 840 is a FIFO in the host receiver to store the sampled data and read out the received data properly to the memory controller. In one example, P0 and P1 would have the preamble samples. Thus, the actual data would start at P2. By adjusting the read pointers to start reading from different locations instead of P0, the data read out of FIFO will be properly aligned as sent by the device. By controlling what should be the start point of the FIFO read will allow the system to read the data properly and compensate for the unmatched receiver design.

Signal 842 represents a DQS or strobe or sampling signal, with a read strobe (RDQS_t) and the complement (RDQS_c). Signal 842 has a preamble of four clock cycles, represented by PRE[0:3]. Signal 844 represents a DQ or data signal. Signal 844 represents eight bits of data transfer, D[0:7]. It can be observed that due to the operation of RX FIFO 840, the data signals of signal 844 are delayed by 1 UI.

In one example, a FIFO read pointer RX FIFO 840 is adjusted. In one example, RX FIFO 840 is split into two halves CK[0] and CK[1]. CK[0] stores the data sampled on RDQS_t and CK[1] stores the data sampled on RDQS_c. Each FIFO has a separate read pointer so the read location can be controlled independently. In normal operation, the pointers read CK[0] and CK[1] together. But here, the data written into FIFO RX 840 is misaligned. To compensate for the mismatch, instead of sampling D0 at CK[0] of P2, D0 is sampled at CK[1] of P1. Thus, Pointer 0 or P0 has PRE[0] and PRE[1] at CK[0] and CK[1], respectively. P1 has PRE[2] at CK[0] and D0 at CK[1]. P2 has D1 at CK[0] and D2 at CK[1]. P3 has D3 at CK[0] and D4 at CK[1]. P4 has D5 at CK[0] and D6 at CK[1]. P5 has D7 at CK[0] and POST[0] at CK[1]. If both FIFOs are read together with the read pointer starting from P0 the data read will be as {(D2,D1), (D4,D3), (D6,D5), (Post0,D7)}, which is incorrect.

Instead of reading the FIFOs together, the FIFO[0] read pointer starts with P1 and the FIFO[1] read pointer starts with P0, then the read data will be {(D0,D1),(D2,D3),(D4,D5),(D6,D7)} which is the data sent by device, but not in proper order.

FIG. 8D is a block diagram of an example of a circuit to selectively swap between separate FIFOs. Reading from the read FIFO without in any change in the pointers could result in incorrect data.

Circuit 808 includes RX FIFO 850, which can be an example of RX FIFO 840. RX FIFO 850 is specifically illustrated to include two separate FIFOs, FIFO[0] and FIFO[1]. In one example, circuit 808 includes multiplexers (muxes), as illustrated by mux 852 and mux 854. Mux 852 and mux 854 can selectively switch or selectively swap the outputs of FIFO[0] and FIFO[1].

It will be understood that if there is no misalignment between the DQ and DQS signals, P0 and P1 of RX FIFO 850 will have the four preamble bits, PRE[0:3]. Thus, the first data bit, D0, will be stored in FIFO[0]. Similarly, if there is a misalignment of an even number of UIs (e.g., 2 UI, 4 UI), D0 will be stored in FIFO[0]. However, if there is a misalignment of an odd number of UIs (e.g., 1 UI, 3 UI), D0 will be stored in FIFO[1], as represented in circuit 808.

Consider an example where the data output is sent to the memory controller as one bit from FIFO[0] and one bit from FIFO[1], represented as {FIFO[1], FIFO[0]}. In such an output in circuit 808 with a 1 UI DQ/DQS offset, the data would be read first from P1, FIFO[1], giving the data as {(D0, D1) (D2, D3) (D4, D5) (D6, D7)}, which is the incorrect data output. With mux 852 and mux 854 swapping the data readout from FIFO[0] and FIFO[1], circuit 808 can read {FIFO[0],FIFO[1]} as illustrated, providing the correct data readout to the memory controller of {(D1, D0) (D3, D2) (D5, D4) (D7, D6)}.

In one example, the control of the muxes is based on the adjustment to the pointers or the adjustment to the operation of the FIFO. When circuit 808 makes an adjustment of an odd number of UIs or odd units of delay by introducing delay into the data, mux 852 and mux 854 can be controlled by the swizzle signal to swap or reorder the FIFO outputs. Mux 852 and mux 854 can represent a swap control circuit.

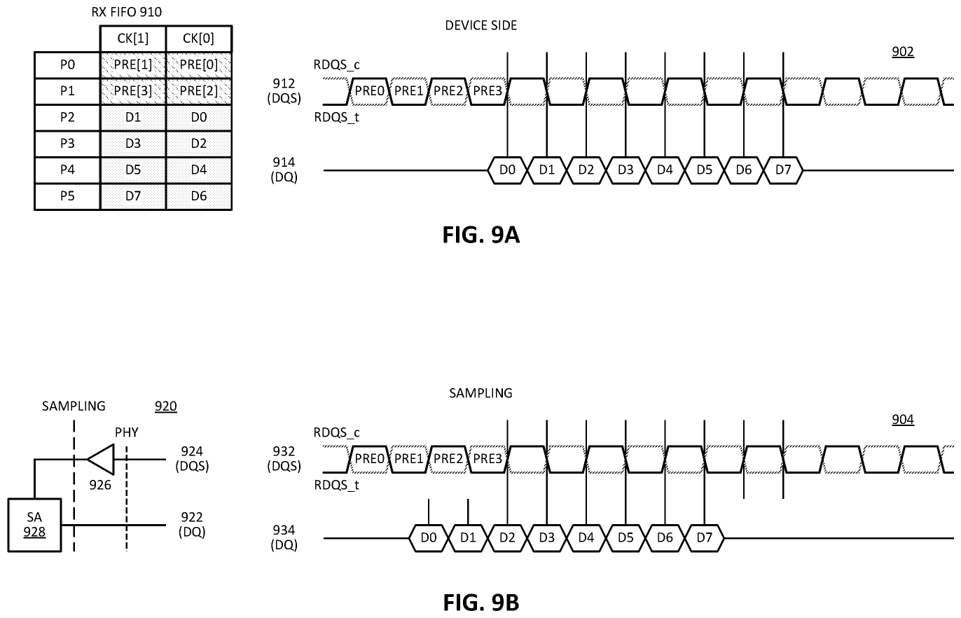

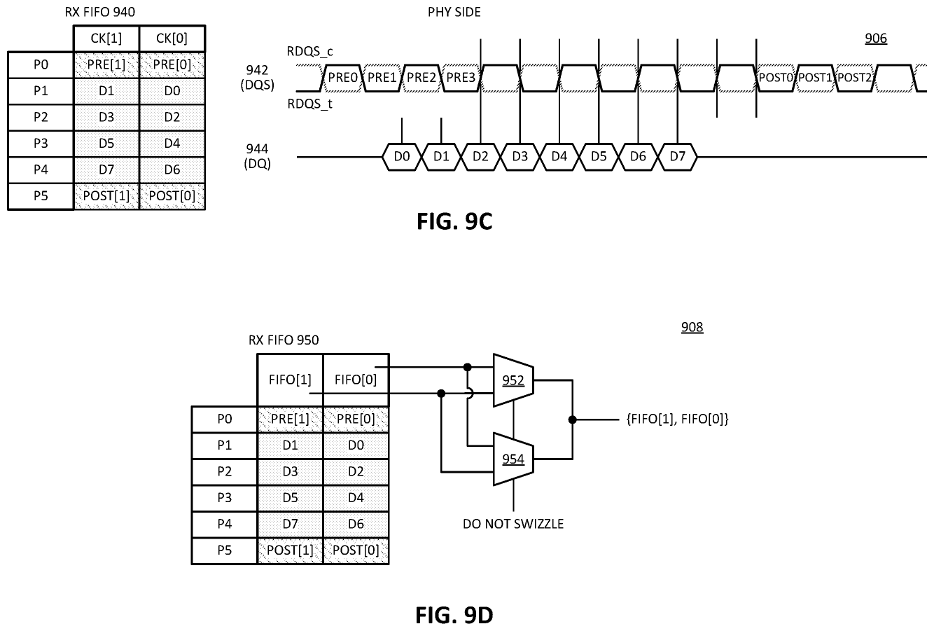

FIGS. 9A-9D are timing diagrams of an example of providing 2 UI delay compensation in a receive data path with selective FIFO swapping. For the 2 UI delay case, the system can adjust the FIFO contents to obtain a 2 UI delay on the data. At the PHY side, the delay of the DQS by 2 UI will result in proper alignment of the data to the DQS before sampling.

FIG. 9A illustrates RX FIFO 910, which represents the FIFO on the PHY layer of the data path for the ideal case (i.e., without delay on DQS) representing alignment from the device side. Diagram 902 represents a timing diagram for RX FIFO 910. Signal 912 represents a DQS or strobe or sampling signal, with a read strobe (RDQS_t) and the complement (RDQS_c). Signal 912 has a preamble of four clock cycles, represented by PRE[0:3]. Signal 914 represents a DQ or data signal. Signal 914 represents eight bits of data transfer, D[0:7]. It can be observed at the device side, the DQS and the DQ signals are aligned.

RX FIFO 910 is split into two portions represented as CK[0] and CK[1]. CK[0] represents the FIFO data that is sampled on the rising edge of RDQS_t and CK[1] represents the FIFO data that is sampled on the rising edge of RDQS_c. In one example, CK[0] and CK[1] will have different read pointer controls. In the ideal case, the entire pointer (CK[0] and CK[1]) is read at the same time. For example, P2 has (D1, D0), P3 has (D3, D2), P4 has (D5, D4), and P5 has (D7, D6). P0 has (PRE[1], PRE[0]) and P1 has (PRE[3], PRE[2]). Diagram 902 shows that DQ is aligned with respect to RDQS on the device side when starting at P0 to result in the data {(D1,D0), (D3,D2), (D5,D4), (D7,D6)}.

FIG. 9B illustrates circuit 920, which is not delay compensated. Signal 922 represents a DQ signal and signal 924 represents a DQS signal. Signal 922 and signal 924 cross the PHY boundary. Circuit 920 has inherent delay in signal 924, as represented by delay 926. In circuit 920, signal 922 and signal 924 cross the sampling boundary for sampling with strong-arm latch (SA) 928 or other sampling circuit. In one example, SA 928 has a comparator and a latch.

Diagram 904 represents a timing diagram for circuit 920. Signal 932 represents a DQS or strobe or sampling signal. Signal 932 is illustrated with a read strobe (RDQS_t) and the complement (RDQS_c). RDQS_t is illustrated as the darker line. Signal 932 has a preamble of four clock cycles, represented by PRE[0:3].

Signal 934 represents a DQ or data signal. Signal 934 represents eight bits of data transfer, D[0:7]. It can be observed that due to delay 926, the data signals of signal 934 are ahead of the strobe, which should start sampling after the preamble. Thus, diagram 904 illustrates a 2 UI mismatch. Sampling with the misaligned DQS would cause incorrect data sampling.

FIG. 9C illustrates RX FIFO 940, which represents a digital component in the data path, and more specifically, in the PHY layer. The system can control the operation of RX FIFO 940 to adjust for the unmatched architecture delay represented in diagram 904.

Diagram 906 represents a timing diagram for RX FIFO 940. In one example, RX FIFO 940 is a FIFO in the host receiver to store the sampled data and read out the received data properly to the memory controller. In one example, P0 and P1 would have the preamble samples. Thus, the actual data would start at P2. By adjusting the read pointers to start reading from different locations instead of P0, the data read out of FIFO will be properly aligned as sent by the device. By controlling the start point of the FIFO read P1 to compensate for the 2 UI mismatch.

Signal 942 represents a DQS or strobe or sampling signal, with a read strobe (RDQS_t) and the complement (RDQS_c). Signal 942 has a preamble of four clock cycles, represented by PRE[0:3]. Signal 944 represents a DQ or data signal. Signal 944 represents eight bits of data transfer, D[0:7]. It can be observed that due to the operation of RX FIFO 940, the data signals of signal 944 are delayed by 2 UI.

In one example, a FIFO read pointer RX FIFO 940 is adjusted. In one example, RX FIFO 940 is split into two halves CK[0] and CK[1]. CK[0] stores the data sampled on RDQS_t and CK[1] stores the data sampled on RDQS_c. Each FIFO has a separate read pointer so the read location can be controlled independently. In normal operation, the pointers read CK[0] and CK[1] together. But here, the data written into FIFO RX 940 is misaligned. To compensate for the mismatch, instead of sampling D0 at CK[0] of P2, D0 is sampled at CK[0] of P1. Thus, Pointer 0 or P0 has PRE[2] and PRE[3] at CK[0] and CK[1], respectively. P1 has D0 at CK[0] and D1 at CK[1]. P2 has D2 at CK[0] and D3 at CK[1]. P3 has D4 at CK[0] and D5 at CK[1]. P4 has D6 at CK[0] and D7 at CK[1]. P5 has POST[0] at CK[0] and POST[1] at CK[1]. If both FIFOs are read together with the read pointer starting from P0 the data read will be as {(D3,D2), (D5,D4), (D7,D6), (Post1,Post0)}, which is incorrect. Instead of reading the FIFOs together expecting data from P2, the FIFOs can be read together expecting data to start with P1. Thus, the read data will be {(D1,D0),(D3,D2),(D5,D4),(D7,D6)} which is the data sent by device and in proper order.

FIG. 9D is a block diagram of an example of a circuit to selectively swap between separate FIFOs. Reading from the read FIFO without in any change in the pointers could result in incorrect data.

Circuit 908 includes RX FIFO 950, which can be an example of RX FIFO 940. RX FIFO 950 is specifically illustrated to include two separate FIFOs, FIFO[0] and FIFO[1]. In one example, circuit 808 includes multiplexers (muxes), as illustrated by mux 952 and mux 954. Mux 952 and mux 954 can selectively switch or selectively swap the outputs of FIFO[0] and FIFO[1].

In the example illustrated in diagram 906, the data output is sent to the memory controller as one bit from FIFO[0] and one bit from FIFO[1], represented as {FIFO[1], FIFO[0]}. In such an output in circuit 908 with a 2 UI DQ/DQS offset, the data would be read first from P1, FIFO[0], giving the data as {(D1, D0) (D3, D2) (D5, D4) (D7, D6)}, which is the correct data output. When circuit 808 makes an adjustment of an even number of UIs or even units of delay, mux 852 and mux 854 can be controlled by a do not swizzle signal to not swap the FIFO outputs.

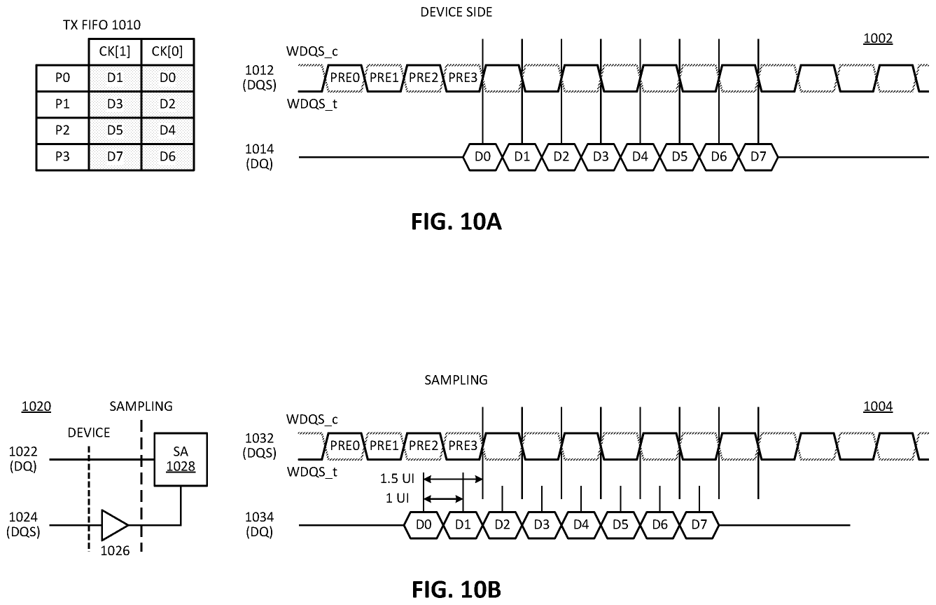

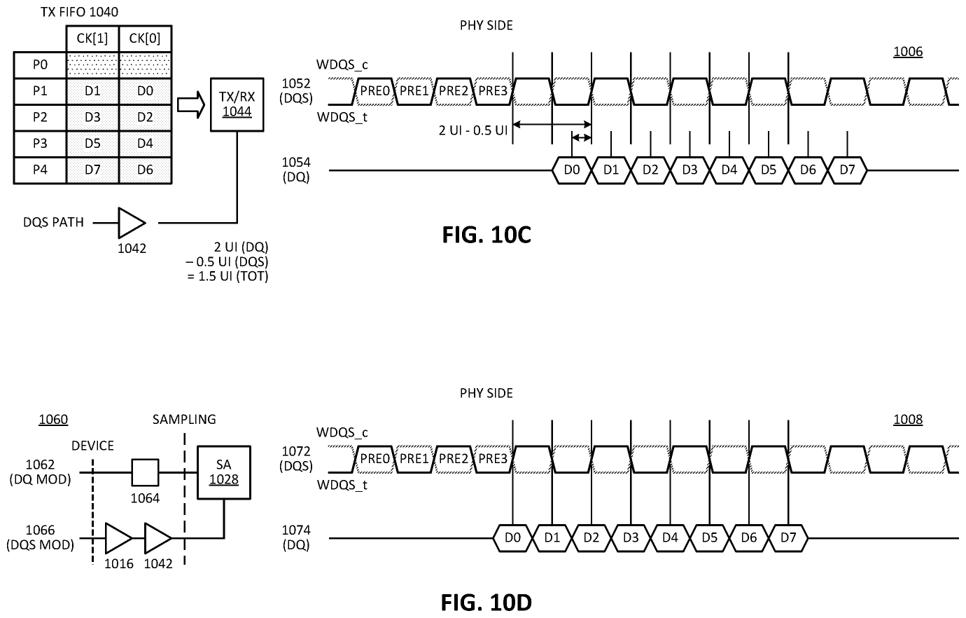

FIGS. 10A-10D are timing diagrams of an example of providing delay compensation for mismatch of 1UI and a partial UI in a transmit data path. In one example, a hardware assisted agent can orchestrate the compensation of the unmatched architecture. In one example, a software assisted agent can orchestrate the compensation of the unmatched architecture. In one example, the agent determines the compensation in a training mode, before functional traffic is sent or received. Training typically involves the use of known data patterns, where the data is exchanged back and forth with different interface settings or parameters until the expected data is received.

In one example, the training can have two major loops: 1) compensation for UI shift, and 2) compensation for sub-UI shift. Compensation for UI shift can adjust for whole UI units of shift, such as 1 UI, 2 UI, 3 UI, and so forth. Compensation for sub-UI shift can refer to the use of parameter sweeps within a 1 UI range to adjust for delays smaller than 1 UI. In one example, the training applies the smaller sweeps to find the left eye and the right eye of the eye width.

In one example, the system applies digital compensation as described above for whole unit delay shifts, and an analog delay component to compensate for sub-UI delay. The diagrams illustrate a case of 1.5 UI total shift. In one example, the system compensates for sub-UI delay by adjusting the data with a digital component, and also adjust the strobe signal with an analog component. Thus, the data delay can apply delays on whole UIs and rather than providing sub-UI delay with analog components in each data path, the system can adjust the strobe signal with the sub-UI delay. Consider the need for a 1.5 UI delay. In one example, the system delays the DQ signal by 2 UI with a digital component, such as the FIFO, and delays WDQS with an analog delay (reducing the delay mismatch by 0.5), resulting in a 1.5 UI delay between WDQS and DQ.

FIG. 10A illustrates TX FIFO 1010, which represents the FIFO on the PHY layer of the data path for the ideal case (i.e., without delay on DQS) representing alignment from the device side. Diagram 1002 represents a timing diagram for TX FIFO 1010. Signal 1012 represents a DQS or strobe or sampling signal, with a write strobe (WDQS_t) and the complement (WDQS_c). Signal 1012 has a preamble of four clock cycles, represented by PRE[0:3]. Signal 1014 represents a DQ or data signal. Signal 1014 represents eight bits of data transfer, D[0:7]. It can be observed at the device side before sampling, the DQS and the DQ signals are aligned.

TX FIFO 1010 is split into two portions represented as CK[0] and CK[1]. CK[0] represents the FIFO data that will be aligned to the rising edge of WDQS_t and CK[1] represents the FIFO data that will be aligned to the rising edge of WDQS_c. In one example, CK[0] and CK[1] can be written independently, controlled by separate write pointers, and read together with a common read pointer. With a common read pointer, the entire pointer (CK[0] and CK[1]) is read at the same time. For example, P0 has (D1, D0), P1 has (D3, D2), P2 has (D5, D4), and P3 has (D7, D6). Diagram 1002 shows that DQ is aligned with respect to WDQS when read from TX FIFO 1010.

FIG. 1013 illustrates circuit 1020, which is not delay compensated. Signal 1022 represents a DQ signal and signal 1024 represents a DQS signal. Signal 1022 and signal 1024 cross the device boundary. Circuit 1020 has inherent delay in signal 1024, as represented by delay 1026. In circuit 1020, signal 1022 and signal 1024 cross the sampling boundary for sampling with strong-arm latch (SA) 1028 or other sampling circuit. In one example, SA 1028 has a comparator and a latch.

Diagram 1004 represents a timing diagram for circuit 1020. Signal 1032 represents a DQS or strobe or sampling signal. Signal 1032 is illustrated with a write strobe (WDQS_t) and the complement (WDQS_c). WDQS_t is illustrated as the darker line. Signal 1032 has a preamble of four clock cycles.

Signal 1034 represents a DQ or data signal. Signal 1034 represents eight bits of data transfer, D[0:7]. It can be observed that due to delay 1026, the data signals of signal 1034 are ahead of the strobe, which should start sampling after the preamble. Thus, diagram 1004 illustrates a 1.5 UI mismatch. There is a 1 UI mismatch from D0 to D1, and then there is a half UI delay after D1 when the sampling should begin in accordance with the strobe signal. Sampling with the misaligned DQS would cause incorrect data sampling.

FIG. 10C illustrates digital plus analog compensation. TX FIFO 1040 represents a digital component in the data path, and more specifically, in the PHY layer. The system can control the operation of TX FIFO 1040 to adjust for whole UI mismatches in the unmatched architecture delay represented in diagram 1004. Delay 1042 represents a variable analog delay component or analog delay circuit in the TX data strobe path to TX/RX 1044, which represents the data pad. Delay 1042 on WDQS_t/c can adjust for sub-UI mismatches.

Diagram 1006 represents a timing diagram for the compensation of TX FIFO 1040 plus delay 1042 on WDQS_t/c. Signal 1052 represents a DQS or strobe or sampling signal, with a write strobe (WDQS_t) and the complement (WDQS_c). Signal 1052 has a preamble of four clock cycles. Signal 1054 represents a DQ or data signal. Signal 1054 represents eight bits of data transfer, D[0:7]. It can be observed that due to the operation of TX FIFO 1040 and delay 1042, the data signals of signal 1054 are delayed by 1.5 UI relative to the DQS signals, with the 1 UI delay provided by TX FIFO 1040 and the 0.5 UI delay provided by delay 1042. In one example, TX FIFO 1040 provides a 2 UI delay and the 0.5 UI delay of the DQS path reduces the 2 UI offset to 1.5 UI.

In one example, a FIFO write point and FIFO data input for TX FIFO 1040 are adjusted. Instead of sampling D0 at CK[0] of P0, D0 is sampled at CK[0] of P1. Thus, Pointer 0 or P0 has no data signal at CK[0] or CK[1]. P1 has D0 at CK[0] and D1 at CK[1]. P2 has D2 at CK[0] and D3 at CK[1]. P3 has D4 at CK[0] and D5 at CK[1]. P4 has D6 at CK[0] and D7 at CK[1]. The 2 UI adjustment from TX FIFO 1040 provides a digital delay, while delay 1042 can provide the analog delay.

FIG. 10D illustrates circuit 1060, which provides variable delay through digital and analog components in the data path. Signal 1062 represents a modified DQ signal (DQ MOD) and signal 1066 represents a modified DQS signal. Signal 1062 and signal 1066 cross the device boundary. Circuit 1060 illustrates the inherent delay in signal 1066 as delay 1016. Circuit 1060 includes variable delay 1064 provided by TX FIFO 1040 and delay 1042 in the data strobe path. In circuit 1060, delay-adjusted signal 1062 and delay-adjusted signal 1066 cross the sampling boundary for sampling with SA 1028.

Diagram 1008 represents a timing diagram for circuit 1060. Signal 1072 represents a DQS or strobe or sampling signal. Signal 1072 is illustrated with a write strobe (WDQS_t) and the complement (WDQS_c). WDQS_t is illustrated as the darker line. Signal 1072 has a preamble of four clock cycles, represented by PRE[0:3].

Signal 1074 represents a DQ or data signal. Signal 1074 represents eight bits of data transfer, D[0:7]. It can be observed that the combined variable delay of delay 1064 and delay 1042 compensates for delay 1016, aligning the data signals of signal 1074 with the strobe of signal 1072. Thus, diagram 1008 illustrates a 1.5 UI compensation.

The example above is specific to transmit. The same principle can be applied on the receive path to first adjust for the sub-UI shift or shift of less than 1 UI with analog components in the receive path, followed by whole UI shift with the digital components.

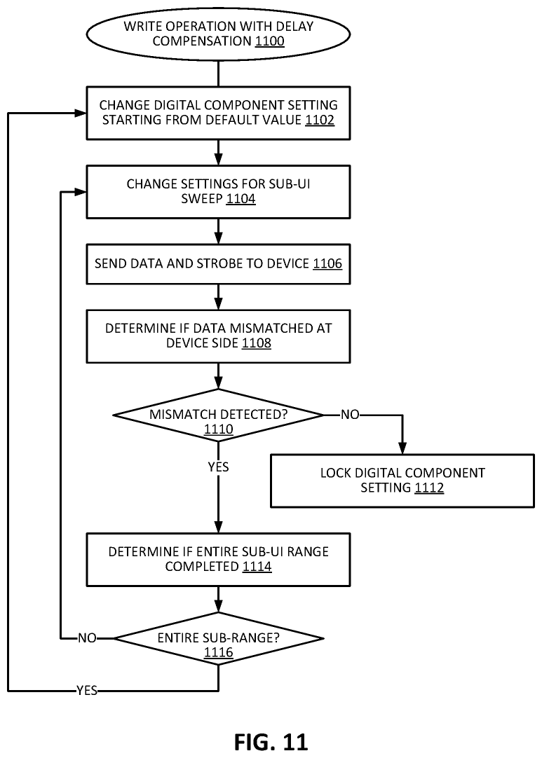

FIG. 11 is a flow diagram of an example of a process for write operation with delay compensation in the physical interface. Process 1100 represents an example of a process for a write operation with delay compensation in accordance with any system described herein. Process 1100 can be executed by a hardware assisted agent or a software assisted agent.

The agent can initialize digital component settings (such as FIFO pointer settings) to default settings or default values. The agent can then determine to change digital component settings from the default value, at 1102. In one example, the agent changes the settings for a sub-UI code sweep within the UI of the digital component setting, at 1104. The sweep can include sending a fixed data pattern to the receiving device as data over a data bus with a strobe sent with the data, at 1106.

The receiving device receives the data and strobe and samples the data with the strobe. The device can compare the known data pattern with the data pattern that is received and determine if the data and strobe is mismatched at the device side. After the PHY sends a specific data pattern, the PHY can receive mismatch information from the receiving device. The PHY can determine if there is a mismatch between the data and the strobe detected on the device side, at 1108. If there is no mismatch detected, at 1110 NO branch, the agent can lock the digital component setting(s), at 1112.

If there is a mismatch detected, at 1110 YES branch, in one example, the agent determines if the entire sub UI range has been completed, at 1114. If the entire sub range has not been completed, at 1116 NO branch, the agent can change to the next sub UI code for a sweep, at 1104. The agent can continue to sweep the entire sub UI range until the right settings are found to result in no mismatch.

In one example, if there is still a mismatch after the entire sub UI range has been checked, at 1116 YES branch, the agent can change the digital component setting to the next UI change and continue to loop through the sweeping through the sub UI codes, at 1102. The agent can continue the testing until no mismatch is detected, at 1110 NO branch. The system can use the locked settings for functional data transfer.

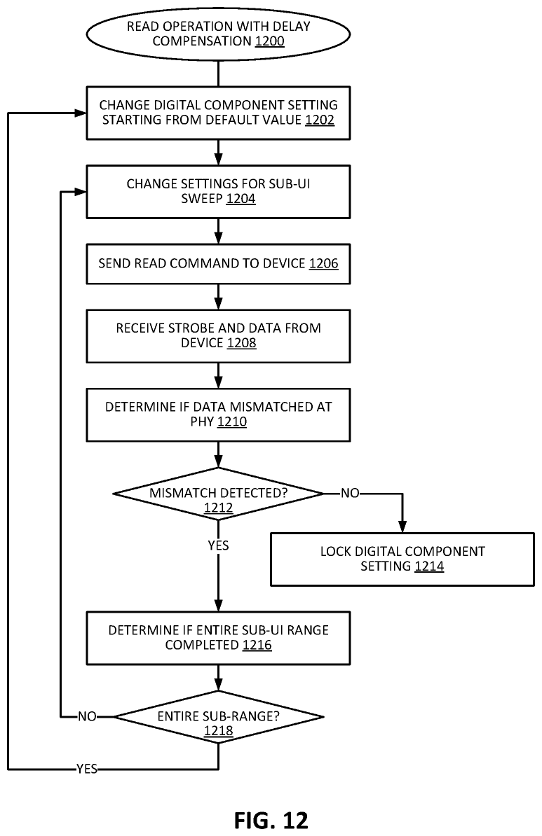

FIG. 12 is a flow diagram of an example of a process for read operation with delay compensation in the physical interface. Process 1200 represents an example of a process for a read operation with delay compensation in accordance with any system described herein. Process 1200 can be executed by a hardware assisted agent or a software assisted agent.

The agent can initialize digital component settings (such as FIFO pointer settings) to default settings or default values. The agent can then determine to change digital component settings from the default value, at 1202. In one example, the agent changes the settings for a sub-UI code sweep within the UI of the digital component setting, at 1204. In one example, the sweep includes sending a read command to the receiving device, at 1206. In response to the read command or read request, the PHY receives data over a data bus with a strobe sent with the data, at 1208.

The PHY receives the data and strobe and samples the data with the strobe and the initiating device determines if the data and strobe is mismatched at the PHY side, at 1210. If there is no mismatch detected, at 1212 NO branch, the agent can lock the digital component setting(s), at 1214.

If there is a mismatch detected, at 1212 YES branch, in one example, the agent determines if the entire sub UI range has been completed, at 1216. If the entire sub range has not been completed, at 1218 NO branch, the agent can change to the next sub UI code for a sweep, at 1204. The agent can continue to sweep the entire sub UI range until the right settings are found to result in no mismatch.

In one example, if there is still a mismatch after the entire sub UI range has been checked, at 1218 YES branch, the agent can change the digital component setting to the next UI change and continue to loop through the sweeping through the sub UI codes, at 1202. The agent can continue the testing until no mismatch is detected, at 1212 NO branch. The system can use the locked settings for functional data transfer.

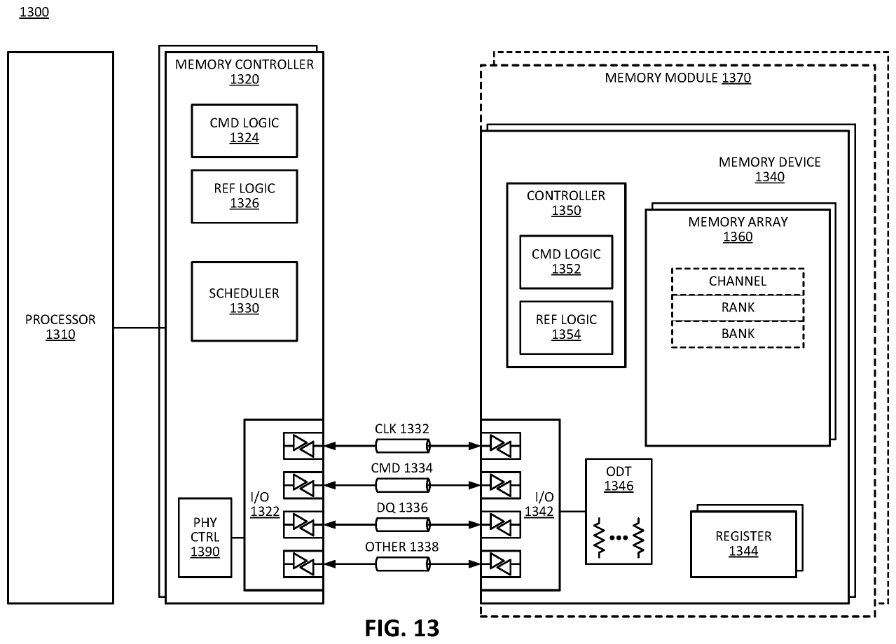

FIG. 13 is a block diagram of an example of a memory subsystem in which delay compensation for an unmatched architecture provided by a physical interface can be implemented. System 1300 includes a processor and elements of a memory subsystem in a computing device. System 1300 represents a system with a memory subsystem in accordance with an example of system 102, an example of system 104, or an example of system 200.

In one example, system 1300 includes PHY control (CTRL) 1390 in memory controller 1320. PHY control 1390 manages the physical interface or PHY between memory controller 1320 and memory device 1340 in accordance with any example herein. In one example, PHY control 1390 can adjust the operation of a digital component to compensate for a delay mismatch due to an unmatched architecture. The digital component is a component in a data path which can introduce a delay to compensate for DQ/DQS mismatch. In one example, PHY control 1390 manages the digital component for UI mismatch and manages an analog delay compensation to adjust for sub-UI mismatch.

Processor 1310 represents a processing unit of a computing platform that may execute an operating system (OS) and applications, which can collectively be referred to as the host or the user of the memory. The OS and applications execute operations that result in memory accesses. Processor 1310 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 1300 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR4 (double data rate version 4, JESD79-4, originally published in September 2012 by JEDEC (Joint Electron Device Engineering Council, now the JEDEC Solid State Technology Association), LPDDR4 (low power DDR version 4, JESD209-4, originally published by JEDEC in August 2014), WIO2 (Wide I/O 2 (WideIO2), JESD229-2, originally published by JEDEC in August 2014), HBM (high bandwidth memory DRAM, JESD235A, originally published by JEDEC in November 2015), DDR5 (DDR version 5, originally published by JEDEC in July 2020), LPDDR5 (LPDDR version 5, JESD209-5, originally published by JEDEC in February 2019), HBM2 (HBM version 2, JESD235C, originally published by JEDEC in January 2020), HBM3 (HBM version 3 currently in discussion by JEDEC), or others or combinations of memory technologies, and technologies based on derivatives or extensions of such specifications.

Memory controller 1320 represents one or more memory controller circuits or devices for system 1300. In one example, memory controller 1320 is on the same semiconductor substrate as processor 1310. Memory controller 1320 represents control logic that generates memory access commands in response to the execution of operations by processor 1310. Memory controller 1320 accesses one or more memory devices 1340. Memory devices 1340 can be DRAM devices in accordance with any referred to above. In one example, memory devices 1340 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 1320 manages a separate memory channel, although system 1300 can be configured to have multiple channels managed by a single controller, or to have multiple controllers on a single channel. In one example, memory controller 1320 is part of host processor 1310, such as logic implemented on the same die or implemented in the same package space as the processor.

Memory controller 1320 includes I/O interface logic 1322 to couple to a memory bus, such as a memory channel as referred to above. I/O interface logic 1322 (as well as I/O interface logic 1342 of memory device 1340) can include pins, pads, connectors, signal lines, traces, or wires, or other hardware to connect the devices, or a combination of these. I/O interface logic 1322 can include a hardware interface. As illustrated, I/O interface logic 1322 includes at least drivers/transceivers for signal lines. Commonly, wires within an integrated circuit interface couple with a pad, pin, or connector to interface signal lines or traces or other wires between devices. I/O interface logic 1322 can include drivers, receivers, transceivers, or termination, or other circuitry or combinations of circuitry to exchange signals on the signal lines between the devices. The exchange of signals includes at least one of transmit or receive. While shown as coupling I/O 1322 from memory controller 1320 to I/O 1342 of memory device 1340, it will be understood that in an implementation of system 1300 where groups of memory devices 1340 are accessed in parallel, multiple memory devices can include I/O interfaces to the same interface of memory controller 1320. In an implementation of system 1300 including one or more memory modules 1370, I/O 1342 can include interface hardware of the memory module in addition to interface hardware on the memory device itself. Other memory controllers 1320 will include separate interfaces to other memory devices 1340.

The bus between memory controller 1320 and memory devices 1340 can be implemented as multiple signal lines coupling memory controller 1320 to memory devices 1340. The bus may typically include at least clock (CLK) 1332, command/address (CMD) 1334, data (DQ) 1336, and zero or more other signal lines 1338. In one example, a bus or connection between memory controller 1320 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 1300 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 1320 and memory devices 1340. An example of a serial bus technology is 9B10B encoding and transmission of high-speed data with embedded clock over a single differential pair of signals in each direction. In one example, CMD 1334 represents signal lines shared in parallel with multiple memory devices. In one example, multiple memory devices share encoding command signal lines of CMD 1334, and each has a separate chip select (CS_n) signal line to select individual memory devices.

It will be understood that in the example of system 1300, the bus between memory controller 1320 and memory devices 1340 includes a subsidiary command bus CMD 1334 and a subsidiary bus to carry the write and read data, DQ 1336. In one example, the data bus can include bidirectional lines for read data and for write/command data. In another example, the subsidiary bus DQ 1336 can include unidirectional write signal lines for write and data from the host to memory, and can include unidirectional lines for read data from the memory to the host. In accordance with the chosen memory technology and system design, other signals 1338 may accompany a bus or sub bus, such as strobe lines DQS. Based on design of system 1300, or implementation if a design supports multiple implementations, the data bus can have more or less bandwidth per memory device 1340. For example, the data bus can support memory devices that have either a x4 interface, a x8 interface, a x16 interface, or other interface. The convention “xW,” where W is an integer that refers to an interface size or width of the interface of memory device 1340, which represents a number of signal lines to exchange data with memory controller 1320. The interface size of the memory devices is a controlling factor on how many memory devices can be used concurrently per channel in system 1300 or coupled in parallel to the same signal lines. In one example, high bandwidth memory devices, wide interface devices, or stacked memory configurations, or combinations, can enable wider interfaces, such as a x128 interface, a x256 interface, a x512 interface, a x1024 interface, or other data bus interface width.

In one example, memory devices 1340 and memory controller 1320 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 1340 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

Memory devices 1340 represent memory resources for system 1300. In one example, each memory device 1340 is a separate memory die. In one example, each memory device 1340 can interface with multiple (e.g., 2) channels per device or die. Each memory device 1340 includes I/O interface logic 1342, which has a bandwidth determined by the implementation of the device (e.g., x16 or x8 or some other interface bandwidth). I/O interface logic 1342 enables the memory devices to interface with memory controller 1320. I/O interface logic 1342 can include a hardware interface, and can be in accordance with I/O 1322 of memory controller, but at the memory device end. In one example, multiple memory devices 1340 are connected in parallel to the same command and data buses. In another example, multiple memory devices 1340 are connected in parallel to the same command bus, and are connected to different data buses. For example, system 1300 can be configured with multiple memory devices 1340 coupled in parallel, with each memory device responding to a command, and accessing memory resources 1360 internal to each. For a Write operation, an individual memory device 1340 can write a portion of the overall data word, and for a Read operation, an individual memory device 1340 can fetch a portion of the overall data word. The remaining bits of the word will be provided or received by other memory devices in parallel.

In one example, memory devices 1340 are disposed directly on a motherboard or host system platform (e.g., a PCB (printed circuit board) or substrate on which processor 1310 is disposed) of a computing device. In one example, memory devices 1340 can be organized into memory modules 1370. In one example, memory modules 1370 represent dual inline memory modules (DIMMs). In one example, memory modules 1370 represent other organization of multiple memory devices to share at least a portion of access or control circuitry, which can be a separate circuit, a separate device, or a separate board from the host system platform. Memory modules 1370 can include multiple memory devices 1340, and the memory modules can include support for multiple separate channels to the included memory devices disposed on them. In another example, memory devices 1340 may be incorporated into the same package as memory controller 1320, such as by techniques such as multi-chip-module (MCM), package-on-package, through-silicon via (TSV), or other techniques or combinations. Similarly, in one example, multiple memory devices 1340 may be incorporated into memory modules 1370, which themselves may be incorporated into the same package as memory controller 1320. It will be appreciated that for these and other implementations, memory controller 1320 may be part of host processor 1310.

Memory devices 1340 each include one or more memory arrays 1360. Memory array 1360 represents addressable memory locations or storage locations for data. Typically, memory array 1360 is managed as rows of data, accessed via wordline (rows) and bitline (individual bits within a row) control. Memory array 1360 can be organized as separate channels, ranks, and banks of memory. Channels may refer to independent control paths to storage locations within memory devices 1340. Ranks may refer to common locations across multiple memory devices (e.g., same row addresses within different devices) in parallel. Banks may refer to sub-arrays of memory locations within a memory device 1340. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 1340 include one or more registers 1344. Register 1344 represents one or more storage devices or storage locations that provide configuration or settings for the operation of the memory device. In one example, register 1344 can provide a storage location for memory device 1340 to store data for access by memory controller 1320 as part of a control or management operation. In one example, register 1344 includes one or more Mode Registers. In one example, register 1344 includes one or more multipurpose registers. The configuration of locations within register 1344 can configure memory device 1340 to operate in different “modes,” where command information can trigger different operations within memory device 1340 based on the mode. Additionally or in the alternative, different modes can also trigger different operation from address information or other signal lines depending on the mode. Settings of register 1344 can indicate configuration for I/O settings (e.g., timing, termination or ODT (on-die termination) 1346, driver configuration, or other I/O settings).

In one example, memory device 1340 includes ODT 1346 as part of the interface hardware associated with I/O 1342. ODT 1346 can be configured as mentioned above, and provide settings for impedance to be applied to the interface to specified signal lines. In one example, ODT 1346 is applied to DQ signal lines. In one example, ODT 1346 is applied to command signal lines. In one example, ODT 1346 is applied to address signal lines. In one example, ODT 1346 can be applied to any combination of the preceding. The ODT settings can be changed based on whether a memory device is a selected target of an access operation or a non-target device. ODT 1346 settings can affect the timing and reflections of signaling on the terminated lines. Careful control over ODT 1346 can enable higher-speed operation with improved matching of applied impedance and loading. ODT 1346 can be applied to specific signal lines of I/O interface 1342, 1322 (for example, ODT for DQ lines or ODT for CA lines), and is not necessarily applied to all signal lines.

Memory device 1340 includes controller 1350, which represents control logic within the memory device to control internal operations within the memory device. For example, controller 1350 decodes commands sent by memory controller 1320 and generates internal operations to execute or satisfy the commands. Controller 1350 can be referred to as an internal controller, and is separate from memory controller 1320 of the host. Controller 1350 can determine what mode is selected based on register 1344, and configure the internal execution of operations for access to memory resources 1360 or other operations based on the selected mode. Controller 1350 generates control signals to control the routing of bits within memory device 1340 to provide a proper interface for the selected mode and direct a command to the proper memory locations or addresses. Controller 1350 includes command logic 1352, which can decode command encoding received on command and address signal lines. Thus, command logic 1352 can be or include a command decoder. With command logic 1352, memory device can identify commands and generate internal operations to execute requested commands.

Referring again to memory controller 1320, memory controller 1320 includes command (CMD) logic 1324, which represents logic or circuitry to generate commands to send to memory devices 1340. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 1340, memory controller 1320 can issue commands via I/O 1322 to cause memory device 1340 to execute the commands. In one example, controller 1350 of memory device 1340 receives and decodes command and address information received via I/O 1342 from memory controller 1320. Based on the received command and address information, controller 1350 can control the timing of operations of the logic and circuitry within memory device 1340 to execute the commands. Controller 1350 is responsible for compliance with standards or specifications within memory device 1340, such as timing and signaling requirements. Memory controller 1320 can implement compliance with standards or specifications by access scheduling and control.

Memory controller 1320 includes scheduler 1330, which represents logic or circuitry to generate and order transactions to send to memory device 1340. From one perspective, the primary function of memory controller 1320 could be said to schedule memory access and other transactions to memory device 1340. Such scheduling can include generating the transactions themselves to implement the requests for data by processor 1310 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 1320 typically includes logic such as scheduler 1330 to allow selection and ordering of transactions to improve performance of system 1300. Thus, memory controller 1320 can select which of the outstanding transactions should be sent to memory device 1340 in which order, which is typically achieved with logic much more complex that a simple first-in first-out algorithm. Memory controller 1320 manages the transmission of the transactions to memory device 1340, and manages the timing associated with the transaction. In one example, transactions have deterministic timing, which can be managed by memory controller 1320 and used in determining how to schedule the transactions with scheduler 1330.

In one example, memory controller 1320 includes refresh (REF) logic 1326. Refresh logic 1326 can be used for memory resources that are volatile and need to be refreshed to retain a deterministic state. In one example, refresh logic 1326 indicates a location for refresh, and a type of refresh to perform. Refresh logic 1326 can trigger self-refresh within memory device 1340, or execute external refreshes which can be referred to as auto refresh commands) by sending refresh commands, or a combination. In one example, controller 1350 within memory device 1340 includes refresh logic 1354 to apply refresh within memory device 1340. In one example, refresh logic 1354 generates internal operations to perform refresh in accordance with an external refresh received from memory controller 1320. Refresh logic 1354 can determine if a refresh is directed to memory device 1340, and what memory resources 1360 to refresh in response to the command.

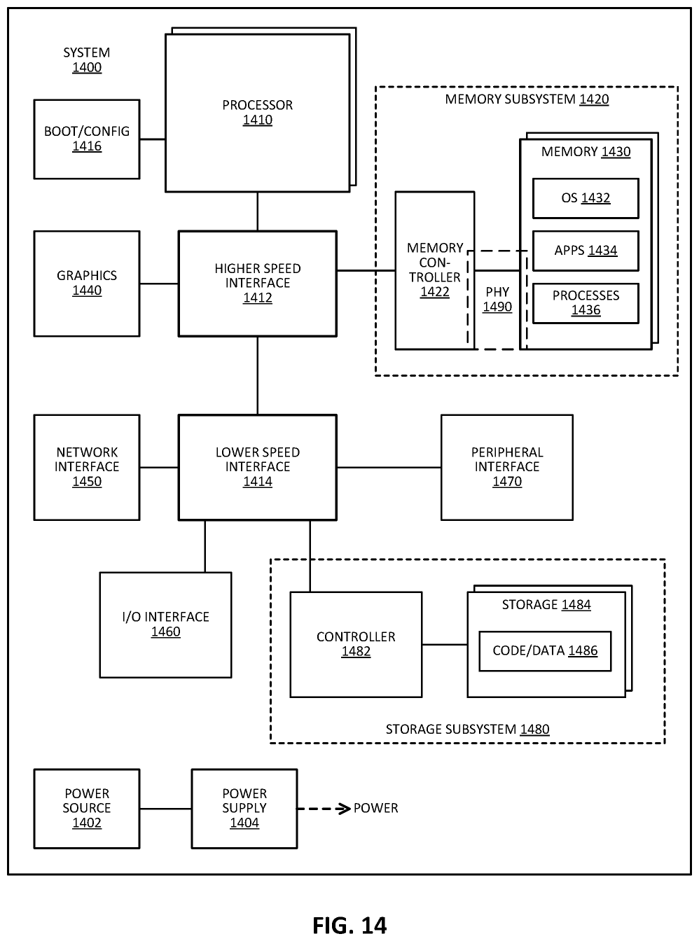

FIG. 14 is a block diagram of an example of a computing system in which delay compensation for an unmatched architecture provided by a physical interface can be implemented. System 1400 represents a computing device in accordance with any example herein, and can be a laptop computer, a desktop computer, a tablet computer, a server, a gaming or entertainment control system, embedded computing device, or other electronic device. System 1400 represents a system with a memory subsystem in accordance with an example of system 102, an example of system 104, or an example of system 200.

In one example, system 1400 includes PHY 1490 to couple memory controller 1422 with memory 1430. PHY 1490 represents the physical interface logic between memory controller 1422 and memory 1430. In one example, the system can control PHY 1490 in accordance with any example herein to adjust the operation of a digital component to compensate for a delay mismatch due to an unmatched architecture. The digital component is a component in a data path which can introduce a delay to compensate for DQ/DQS mismatch. In one example, PHY 1490 provides UI mismatch compensation with a digital component and sub-UI mismatch compensation with an analog component in the data path.

System 1400 includes processor 1410 can include any type of microprocessor, central processing unit (CPU), graphics processing unit (GPU), processing core, or other processing hardware, processor device, or a combination, to provide processing or execution of instructions for system 1400. Processor 1410 controls the overall operation of system 1400, and can be or include, one or more programmable general-purpose or special-purpose microprocessors, digital signal processors (DSPs), programmable controllers, application specific integrated circuits (ASICs), programmable logic devices (PLDs), or a combination of such devices. Processor 1410 can be considered a host processor device for system 1400.

System 1400 includes boot/config 1416, which represents storage to store boot code (e.g., basic input/output system (BIOS)), configuration settings, security hardware (e.g., trusted platform module (TPM)), or other system level hardware that operates outside of a host OS. Boot/config 1416 can include a nonvolatile storage device, such as read-only memory (ROM), flash memory, or other memory devices.

In one example, system 1400 includes interface 1412 coupled to processor 1410, which can represent a higher speed interface or a high throughput interface for system components that need higher bandwidth connections, such as memory subsystem 1420 or graphics interface components 1440. Interface 1412 represents an interface circuit, which can be a standalone component or integrated onto a processor die. Interface 1412 can be integrated as a circuit onto the processor die or integrated as a component on a system on a chip. Where present, graphics interface 1440 interfaces to graphics components for providing a visual display to a user of system 1400. Graphics interface 1440 can be a standalone component or integrated onto the processor die or system on a chip. In one example, graphics interface 1440 can drive a high definition (HD) display or ultra high definition (UHD) display that provides an output to a user. In one example, the display can include a touchscreen display. In one example, graphics interface 1440 generates a display based on data stored in memory 1430 or based on operations executed by processor 1410 or both.

Memory subsystem 1420 represents the main memory of system 1400, and provides storage for code to be executed by processor 1410, or data values to be used in executing a routine. Memory subsystem 1420 can include one or more memory devices 1430 such as read-only memory (ROM), flash memory, one or more varieties of random access memory (RAM) such as DRAM, 3DXP (three-dimensional crosspoint), or other memory devices, or a combination of such devices. Memory 1430 stores and hosts, among other things, operating system (OS) 1432 to provide a software platform for execution of instructions in system 1400. Additionally, applications 1434 can execute on the software platform of OS 1432 from memory 1430. Applications 1434 represent programs that have their own operational logic to perform execution of one or more functions. Processes 1436 represent agents or routines that provide auxiliary functions to OS 1432 or one or more applications 1434 or a combination. OS 1432, applications 1434, and processes 1436 provide software logic to provide functions for system 1400. In one example, memory subsystem 1420 includes memory controller 1422, which is a memory controller to generate and issue commands to memory 1430. It will be understood that memory controller 1422 could be a physical part of processor 1410 or a physical part of interface 1412. For example, memory controller 1422 can be an integrated memory controller, integrated onto a circuit with processor 1410, such as integrated onto the processor die or a system on a chip.

While not specifically illustrated, it will be understood that system 1400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 1400 includes interface 1414, which can be coupled to interface 1412. Interface 1414 can be a lower speed interface than interface 1412. In one example, interface 1414 represents an interface circuit, which can include standalone components and integrated circuitry. In one example, multiple user interface components or peripheral components, or both, couple to interface 1414. Network interface 1450 provides system 1400 the ability to communicate with remote devices (e.g., servers or other computing devices) over one or more networks. Network interface 1450 can include an Ethernet adapter, wireless interconnection components, cellular network interconnection components, USB (universal serial bus), or other wired or wireless standards-based or proprietary interfaces. Network interface 1450 can exchange data with a remote device, which can include sending data stored in memory or receiving data to be stored in memory.

In one example, system 1400 includes one or more input/output (I/O) interface(s) 1460. I/O interface 1460 can include one or more interface components through which a user interacts with system 1400 (e.g., audio, alphanumeric, tactile/touch, or other interfacing). Peripheral interface 1470 can include any hardware interface not specifically mentioned above. Peripherals refer generally to devices that connect dependently to system 1400. A dependent connection is one where system 1400 provides the software platform or hardware platform or both on which operation executes, and with which a user interacts.

In one example, system 1400 includes storage subsystem 1480 to store data in a nonvolatile manner. In one example, in certain system implementations, at least certain components of storage 1480 can overlap with components of memory subsystem 1420. Storage subsystem 1480 includes storage device(s) 1484, which can be or include any conventional medium for storing large amounts of data in a nonvolatile manner, such as one or more magnetic, solid state, 3DXP, or optical based disks, or a combination. Storage 1484 holds code or instructions and data 1486 in a persistent state (i.e., the value is retained despite interruption of power to system 1400). Storage 1484 can be generically considered to be a “memory,” although memory 1430 is typically the executing or operating memory to provide instructions to processor 1410. Whereas storage 1484 is nonvolatile, memory 1430 can include volatile memory (i.e., the value or state of the data is indeterminate if power is interrupted to system 1400). In one example, storage subsystem 1480 includes controller 1482 to interface with storage 1484. In one example controller 1482 is a physical part of interface 1414 or processor 1410, or can include circuits or logic in both processor 1410 and interface 1414.

Power source 1402 provides power to the components of system 1400. More specifically, power source 1402 typically interfaces to one or multiple power supplies 1404 in system 1400 to provide power to the components of system 1400. In one example, power supply 1404 includes an AC to DC (alternating current to direct current) adapter to plug into a wall outlet. Such AC power can be renewable energy (e.g., solar power) power source 1402. In one example, power source 1402 includes a DC power source, such as an external AC to DC converter. In one example, power source 1402 or power supply 1404 includes wireless charging hardware to charge via proximity to a charging field. In one example, power source 1402 can include an internal battery or fuel cell source.

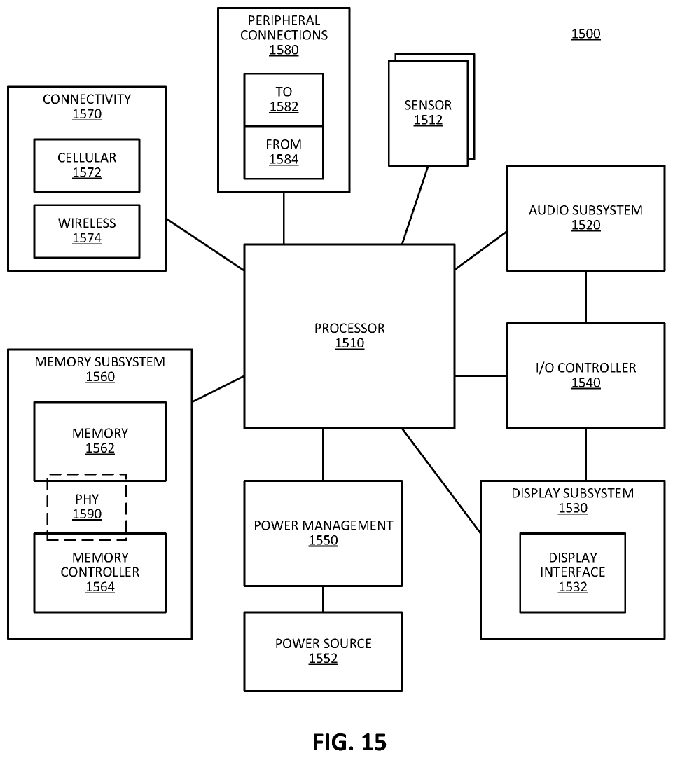

FIG. 15 is a block diagram of an example of a mobile device in which delay compensation for an unmatched architecture provided by a physical interface can be implemented. System 1500 represents a mobile computing device, such as a computing tablet, a mobile phone or smartphone, wearable computing device, or other mobile device, or an embedded computing device. It will be understood that certain of the components are shown generally, and not all components of such a device are shown in system 1500. System 1500 can be or include a system in accordance with an example of system 102, an example of system 104, or an example of system 200.

In one example, system 1500 includes PHY 1590 to couple memory controller 1564 with memory 1562. PHY 1590 represents the physical interface logic between memory controller 1564 and memory 1562. In one example, the system can control PHY 1590 in accordance with any example herein to adjust the operation of a digital component to compensate for a delay mismatch due to an unmatched architecture. The digital component is a component in a data path which can introduce a delay to compensate for DQ/DQS mismatch. In one example, PHY 1590 provides UI mismatch compensation with a digital component and sub-UI mismatch compensation with an analog component in the data path.

System 1500 includes processor 1510, which performs the primary processing operations of system 1500. Processor 1510 can include one or more physical devices, such as microprocessors, application processors, microcontrollers, programmable logic devices, or other processing means or processor devices. Processor 1510 can be considered a host processor device for system 1500. The processing operations performed by processor 1510 include the execution of an operating platform or operating system on which applications and device functions are executed. The processing operations include operations related to I/O (input/output) with a human user or with other devices, operations related to power management, operations related to connecting system 1500 to another device, or a combination. The processing operations can also include operations related to audio I/O, display I/O, or other interfacing, or a combination. Processor 1510 can execute data stored in memory. Processor 1510 can write or edit data stored in memory.

In one example, system 1500 includes one or more sensors 1512. Sensors 1512 represent embedded sensors or interfaces to external sensors, or a combination. Sensors 1512 enable system 1500 to monitor or detect one or more conditions of an environment or a device in which system 1500 is implemented. Sensors 1512 can include environmental sensors (such as temperature sensors, motion detectors, light detectors, cameras, chemical sensors (e.g., carbon monoxide, carbon dioxide, or other chemical sensors)), pressure sensors, accelerometers, gyroscopes, medical or physiology sensors (e.g., biosensors, heart rate monitors, or other sensors to detect physiological attributes), or other sensors, or a combination. Sensors 1512 can also include sensors for biometric systems such as fingerprint recognition systems, face detection or recognition systems, or other systems that detect or recognize user features. Sensors 1512 should be understood broadly, and not limiting on the many different types of sensors that could be implemented with system 1500. In one example, one or more sensors 1512 couples to processor 1510 via a frontend circuit integrated with processor 1510. In one example, one or more sensors 1512 couples to processor 1510 via another component of system 1500.

In one example, system 1500 includes audio subsystem 1520, which represents hardware (e.g., audio hardware and audio circuits) and software (e.g., drivers, codecs) components associated with providing audio functions to the computing device. Audio functions can include speaker or headphone output, as well as microphone input. Devices for such functions can be integrated into system 1500, or connected to system 1500. In one example, a user interacts with system 1500 by providing audio commands that are received and processed by processor 1510.

Display subsystem 1530 represents hardware (e.g., display devices) and software components (e.g., drivers) that provide a visual display for presentation to a user. In one example, the display includes tactile components or touchscreen elements for a user to interact with the computing device. Display subsystem 1530 includes display interface 1532, which includes the particular screen or hardware device used to provide a display to a user. In one example, display interface 1532 includes logic separate from processor 1510 (such as a graphics processor) to perform at least some processing related to the display. In one example, display subsystem 1530 includes a touchscreen device that provides both output and input to a user. In one example, display subsystem 1530 includes a high definition (HD) or ultra-high definition (UHD) display that provides an output to a user. In one example, display subsystem includes or drives a touchscreen display. In one example, display subsystem 1530 generates display information based on data stored in memory or based on operations executed by processor 1510 or both.

I/O controller 1540 represents hardware devices and software components related to interaction with a user. I/O controller 1540 can operate to manage hardware that is part of audio subsystem 1520, or display subsystem 1530, or both. Additionally, I/O controller 1540 illustrates a connection point for additional devices that connect to system 1500 through which a user might interact with the system. For example, devices that can be attached to system 1500 might include microphone devices, speaker or stereo systems, video systems or other display device, keyboard or keypad devices, buttons/switches, or other I/O devices for use with specific applications such as card readers or other devices.

As mentioned above, I/O controller 1540 can interact with audio subsystem 1520 or display subsystem 1530 or both. For example, input through a microphone or other audio device can provide input or commands for one or more applications or functions of system 1500. Additionally, audio output can be provided instead of or in addition to display output. In another example, if display subsystem includes a touchscreen, the display device also acts as an input device, which can be at least partially managed by I/O controller 1540. There can also be additional buttons or switches on system 1500 to provide I/O functions managed by I/O controller 1540.

In one example, I/O controller 1540 manages devices such as accelerometers, cameras, light sensors or other environmental sensors, gyroscopes, global positioning system (GPS), or other hardware that can be included in system 1500, or sensors 1512. The input can be part of direct user interaction, as well as providing environmental input to the system to influence its operations (such as filtering for noise, adjusting displays for brightness detection, applying a flash for a camera, or other features).

In one example, system 1500 includes power management 1550 that manages battery power usage, charging of the battery, and features related to power saving operation. Power management 1550 manages power from power source 1552, which provides power to the components of system 1500. In one example, power source 1552 includes an AC to DC (alternating current to direct current) adapter to plug into a wall outlet. Such AC power can be renewable energy (e.g., solar power, motion based power). In one example, power source 1552 includes only DC power, which can be provided by a DC power source, such as an external AC to DC converter. In one example, power source 1552 includes wireless charging hardware to charge via proximity to a charging field. In one example, power source 1552 can include an internal battery or fuel cell source.

Memory subsystem 1560 includes memory device(s) 1562 for storing information in system 1500. Memory subsystem 1560 can include nonvolatile (state does not change if power to the memory device is interrupted) or volatile (state is indeterminate if power to the memory device is interrupted) memory devices, or a combination. Memory 1560 can store application data, user data, music, photos, documents, or other data, as well as system data (whether long-term or temporary) related to the execution of the applications and functions of system 1500. In one example, memory subsystem 1560 includes memory controller 1564 (which could also be considered part of the control of system 1500, and could potentially be considered part of processor 1510). Memory controller 1564 includes a scheduler to generate and issue commands to control access to memory device 1562.

Connectivity 1570 includes hardware devices (e.g., wireless or wired connectors and communication hardware, or a combination of wired and wireless hardware) and software components (e.g., drivers, protocol stacks) to enable system 1500 to communicate with external devices. The external device could be separate devices, such as other computing devices, wireless access points or base stations, as well as peripherals such as headsets, printers, or other devices. In one example, system 1500 exchanges data with an external device for storage in memory or for display on a display device. The exchanged data can include data to be stored in memory, or data already stored in memory, to read, write, or edit data.

Connectivity 1570 can include multiple different types of connectivity. To generalize, system 1500 is illustrated with cellular connectivity 1572 and wireless connectivity 1574. Cellular connectivity 1572 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), 5G, or other cellular service standards. Wireless connectivity 1574 refers to wireless connectivity that is not cellular, and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium.

Peripheral connections 1580 include hardware interfaces and connectors, as well as software components (e.g., drivers, protocol stacks) to make peripheral connections. It will be understood that system 1500 could both be a peripheral device (“to” 1582) to other computing devices, as well as have peripheral devices (“from” 1584) connected to it. System 1500 commonly has a “docking” connector to connect to other computing devices for purposes such as managing (e.g., downloading, uploading, changing, synchronizing) content on system 1500. Additionally, a docking connector can allow system 1500 to connect to certain peripherals that allow system 1500 to control content output, for example, to audiovisual or other systems.

In addition to a proprietary docking connector or other proprietary connection hardware, system 1500 can make peripheral connections 1580 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), or other type.

Example 1 is an apparatus including: a data (DQ) path of a physical interface (PHY) of a memory subsystem; a data strobe (DQS) path of the PHY, wherein delay propagation of analog signals in the DQS path and the DQ path is mismatched; and a digital component in the PHY to receive a control signal to introduce a delay compensation in operation of the digital component to compensate for delay propagation mismatch between the DQS path and the DQ path.

Example 2 is an apparatus in accordance with Example 1, wherein the digital component comprises a component in the DQ path.

Example 3 is an apparatus in accordance with Example 2, wherein the digital component comprises a first in first out (FIFO) buffer.

Example 4 is an apparatus in accordance with Example 3, wherein the FIFO buffer comprises a read buffer.

Example 5 is an apparatus in accordance with Example 3, wherein the FIFO buffer comprises a write buffer.

Example 6 is an apparatus in accordance with Example 3, wherein the digital component comprises a first FIFO buffer and a second FIFO buffer.

Example 7 is an apparatus in accordance with Example 6, further including: a swap control circuit to selectively reorder data readout from the first FIFO buffer and the second FIFO buffer based on introduction of odd or even units of delay compensation.

Example 8 is an apparatus in accordance with Example 1, wherein the digital component comprises a component in the DQS path.

Example 9 is an apparatus in accordance with Example 8, wherein the digital component comprises a shifter.

Example 10 is an apparatus in accordance with Example 1, wherein the digital component comprises a first in first out (FIFO) buffer, and wherein to introduce the delay compensation in operation of the FIFO buffer comprises to adjust a write pointer to the FIFO buffer for a write transaction.

Example 11 is an apparatus in accordance with Example 1, wherein the digital component comprises a first in first out (FIFO) buffer, and wherein to introduce the delay compensation in operation of the FIFO buffer comprises to adjust a read pointer to the FIFO buffer for a read transaction.

Example 12 is an apparatus in accordance with Example 1, wherein the delay compensation comprises a delay in increments of a unit interval (UI).

Example 13 is an apparatus in accordance with Example 12, further including: an analog delay circuit to adjust for delay of less than one UI.

Example 14 is a system including: a memory controller; a memory device; and a physical interface (PHY) to couple the memory controller to the memory device, the PHY having a mismatched architecture, including a data (DQ) path; a data strobe (DQS) path, wherein delay propagation of analog signals in the DQS path and the DQ path is mismatched; and a digital component to receive a control signal to introduce a delay compensation in operation of the digital component to compensate for delay propagation mismatch between the DQS path and the DQ path.

Example 15 is a system in accordance with Example 14, wherein the digital component comprises a component in the DQ path.

Example 16 is a system in accordance with Example 15, wherein the digital component comprises a first in first out (FIFO) buffer.

Example 17 is a system in accordance with Example 16, wherein the FIFO buffer comprises a read buffer.

Example 18 is a system in accordance with Example 16, wherein the FIFO buffer comprises a write buffer.

Example 19 is a system in accordance with Example 16, wherein the digital component comprises a first FIFO buffer and a second FIFO buffer.

Example 20 is a system in accordance with Example 19, further including: a swap control circuit to selectively reorder data readout from the first FIFO buffer and the second FIFO buffer based on introduction of odd or even units of delay compensation.

Example 21 is a system in accordance with Example 14, wherein the digital component comprises a component in the DQS path.

Example 22 is a system in accordance with Example 21, wherein the digital component comprises a shifter.

Example 23 is a system in accordance with Example 14, wherein the digital component comprises a first in first out (FIFO) buffer, and wherein to introduce the delay compensation in operation of the FIFO buffer comprises to adjust a write pointer to the FIFO buffer for a write transaction.

Example 24 is a system in accordance with Example 14, wherein the digital component comprises a first in first out (FIFO) buffer, and wherein to introduce the delay compensation in operation of the FIFO buffer comprises to adjust a read pointer to the FIFO buffer for a read transaction.

Example 25 is a system in accordance with Example 14, wherein the delay compensation comprises a delay in increments of a unit interval (UI).

Example 26 is a system in accordance with Example 25, further including: an analog delay circuit to adjust for delay of less than one UI.

Example 27 is a system in accordance with Example 14, further comprising one or more of: a multicore host processor coupled to the memory controller; a display communicatively coupled to a host processor; a network interface communicatively coupled to a host processor; or a battery to power the system.

Example 28 is a method including: receiving a data signal at a digital component of a physical interface (PHY) of a memory subsystem, the PHY having a data (DQ) path and a data strobe (DQS) path; and receiving a control signal to adjust an operation of the digital component to introduce delay compensation to compensate for delay propagation mismatch between the DQS path and the DQ path.

Example 29 is a method in accordance with Example 28, wherein receiving the data signal at the digital component comprises receiving the data signal at a component in the DQ path.

Example 30 is a method in accordance with Example 29, wherein receiving the data signal at the digital component comprises receiving the data signal at a first in first out (FIFO) buffer.

Example 31 is a method in accordance with Example 30, wherein receiving the data signal at the FIFO buffer comprises receiving the data signal at a read buffer.

Example 32 is a method in accordance with Example 30, wherein receiving the data signal at the FIFO buffer comprises receiving the data signal at a write buffer.

Example 33 is a method in accordance with Example 30, receiving the data signal at the FIFO buffer comprises receiving the data signal at a first FIFO buffer and a second FIFO buffer.

Example 34 is a method in accordance with Example 33, further including: selectively reordering data readout from the first FIFO buffer and the second FIFO buffer based on introduction of odd or even units of delay compensation.

Example 35 is a method in accordance with Example 28, wherein receiving the data signal at the digital component comprises receiving the data signal at a component in the DQS path.

Example 36 is a method in accordance with Example 35, wherein receiving the data signal at the digital component comprises receiving the data signal at a shifter.

Example 37 is a method in accordance with Example 28, wherein receiving the data signal at the digital component comprises receiving the data signal at a first in first out (FIFO) buffer, and wherein introducing the delay compensation in operation of the FIFO buffer comprises adjusting a write pointer to the FIFO buffer for a write transaction.

Example 38 is a method in accordance with Example 28, wherein receiving the data signal at the digital component comprises receiving the data signal at a first in first out (FIFO) buffer, and wherein introducing the delay compensation in operation of the FIFO buffer comprises adjusting a read pointer to the FIFO buffer for a read transaction.

Example 39 is a method in accordance with Example 28, wherein the delay compensation comprises a delay in increments of a unit interval (UI).

Example 40 is a method in accordance with Example 39, further including: adjusting for delay of less than one UI with an analog delay circuit.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. An apparatus comprising:
a data (DQ) path of a physical interface (PHY) of a memory subsystem;
a data strobe (DQS) path of the PHY, wherein delay propagation of analog signals in the DQS path and the DQ path is mismatched; and
a digital component in the PHY to receive a control signal to introduce a delay compensation in operation of the digital component to compensate for delay propagation mismatch between the DQS path and the DQ path.

2. The apparatus of claim 1, wherein the digital component comprises a component in the DQ path.

3. The apparatus of claim 2, wherein the digital component comprises a first in first out (FIFO) buffer.

4. The apparatus of claim 3, wherein the FIFO buffer comprises a read buffer.

5. The apparatus of claim 3, wherein the FIFO buffer comprises a write buffer.

6. The apparatus of claim 3, wherein the digital component comprises a first FIFO buffer and a second FIFO buffer.

7. The apparatus of claim 6, further comprising:
a swap control circuit to selectively reorder data readout from the first FIFO buffer and the second FIFO buffer based on introduction of odd or even units of delay compensation.

8. The apparatus of claim 1, wherein the digital component comprises a component in the DQS path.

9. The apparatus of claim 8, wherein the digital component comprises a shifter.

10. The apparatus of claim 1, wherein the digital component comprises a first in first out (FIFO) buffer, and wherein to introduce the delay compensation in operation of the FIFO buffer comprises to adjust a write pointer to the FIFO buffer for a write transaction.

11. The apparatus of claim 1, wherein the digital component comprises a first in first out (FIFO) buffer, and wherein to introduce the delay compensation in operation of the FIFO buffer comprises to adjust a read pointer to the FIFO buffer for a read transaction.

12. The apparatus of claim 1, wherein the delay compensation comprises a delay in increments of a unit interval (UI).

13. The apparatus of claim 12, further comprising:
an analog delay circuit to adjust for delay of less than one UI.

14. A system, comprising:
a memory controller;
a memory device; and
a physical interface (PHY) to couple the memory controller to the memory device, the PHY having a mismatched architecture, including
a data (DQ) path;
a data strobe (DQS) path, wherein delay propagation of analog signals in the DQS path and the DQ path is mismatched; and
a digital component to receive a control signal to introduce a delay compensation in operation of the digital component to compensate for delay propagation mismatch between the DQS path and the DQ path.

15. The system of claim 14, wherein the digital component comprises a first in first out (FIFO) buffer in the DQ path.

16. The system of claim 14, wherein the digital component comprises a shifter in the DQS path.

17. The system of claim 14, wherein the PHY comprises a physical interface circuit of the memory controller.

18. The system of claim 14, wherein the PHY comprises a physical interface circuit of the memory device.

19. The system of claim 14, further comprising one or more of:
a multicore host processor coupled to the memory controller;
a display communicatively coupled to a host processor;
a network interface communicatively coupled to a host processor; or
a battery to power the system.

20. A method comprising:
receiving a data signal at a digital component of a physical interface (PHY) of a memory subsystem, the PHY having a data (DQ) path and a data strobe (DQS) path; and
receiving a control signal to adjust an operation of the digital component to introduce delay compensation to compensate for delay propagation mismatch between the DQS path and the DQ path.

21. The method of claim 20, wherein receiving the data signal at the digital component comprises receiving a DQ signal at a first in first out (FIFO) buffer of the DQ path of the PHY.

22. The method of claim 20, wherein receiving the data signal at the digital component comprises receiving a DQS signal at a shifter of the DQS path of the PHY.
